(19) United States
(12) Patent Application Publication
(10) Pub. No.: US 2004/0232075 A1
(43) Pub. Date: Nov. 25, 2004

(54) Microfiltration device and method for washing and concentrating solid particles

(76) Inventor: Jason Wells, Santa Clara, CA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/769,546

(22) Filed: Jan. 30, 2004

Related U.S. Application Data
(60) Provisional application No. 60/443,992, filed on Jan. 31, 2003.

(51) Int. Cl. B01D 65/02

(52) U.S. Cl. 210/636; 210/637; 210/321.69; 210/321.65; 210/650

(57) ABSTRACT

The present invention relates to a process for adjusting the composition of a dispersions comprising particulate matter and a fluid medium which comprises separating the dispersion into a plurality of fractions. The present invention particularly relates to a novel apparatus comprising a filter membrane adapted for use in accordance with the process of the present invention. The present invention further relates to a process for adjusting the composition of a plurality of dispersions and a novel apparatus for use in this process.

### REFERENCE TO RELATED APPLICATION

This application claims priority from U.S. Provisional Application Ser. No. 60/443,992, filed Jan. 31, 2003, the entire contents of which are incorporated herein by reference.

### FIELD OF THE INVENTION

The present invention relates to a process for adjusting the composition of a dispersion comprising particulate matter and a fluid medium which comprises separating the dispersion into a plurality of fractions. The present invention particularly relates to a novel apparatus comprising a filter membrane adapted for use in accordance with the process of the present invention. The present invention further relates to a process for adjusting the composition of a plurality of dispersions and a novel apparatus for use in this process.

### BACKGROUND OF THE INVENTION

The process of the present invention incorporates features of a filtration process and may be used to filter dispersions containing particulate matter to produce a concentrated dispersion and a stream containing a reduced concentration of particulate matter. The dispersion to be treated may comprise a liquid medium having ionic materials distributed therein. The process of the present invention may also include addition of a liquid to the dispersion to reduce the concentration of particulate matter or ionic materials present in the dispersion. Such an operation is commonly referred to as washing and it is generally included when a product of increased purity is desired.

Filter membranes used in filtration processes are commonly tubular porous membranes to which the fluid to be filtered is introduced via a process fluid inlet with filtration occurring by passage of fluid substantially free of solid particles of a certain size through the walls of the membrane. Generally, and for purposes of this discussion, the stream which passes through the filter membrane is referred to as the permeate stream. The permeate stream passes through the filter membrane by virtue of a pressure differential across the filter membrane and solid particles are retained within the tubular membrane. The membrane is selected such that only those particles not desired to be retained within the membrane can pass through the membrane along with the permeate. Fluid which does not exit the filter through the walls of the membrane as permeate exits the filter via a process fluid outlet. Filters of this type are commonly referred to as “cross-flow” filters and will be referred to as such for purposes of this discussion.

For purposes of this discussion, flow or location will be characterized as upstream or downstream with reference to the flow of fluid through a filter membrane. Thus, a characterization of upstream will refer to any component which has not passed through a filter membrane and, accordingly, downstream will refer to any component which has passed through a filter membrane.

Processes utilizing cross-flow filters which also include washing generally require a large volume of wash liquid relative to the volume of retentate ultimately produced, and are typically only suitable for treating mixtures containing a low concentration of particles.

Another type of filter which may be used in filtration operations is commonly referred to as “trans-flow” or “dead end” (hereinafter “trans-flow”). Filter membranes of this type may be substantially planar but more typically are in the shape of an inverted disc as viewed from the upstream side of the filter membrane, relative to the flow of fluid therethrough, and are adapted for exposure to the mixture to be filtered thereby causing fluid to pass through the filter membrane under the influence of a pressure differential. Generally, the filter membrane is exposed to the mixture by introducing the filter membrane to a vessel containing the mixture. In contrast to “cross-flow” filters, the substantially planar or, disc-shaped, “trans-flow” filters do not possess a process fluid outlet upstream of the filter membrane.

Membrane filters of these two types are commonly used for filtration of mixtures containing particles that are microscopic in size (i.e., of a size below about 1 μm). These processes are commonly referred to as “microfiltration” or “ultrafiltration” (hereinafter “microfiltration”). Microfiltration is commonly used in water purification and beverage processing in which solid contaminants are generally present in concentrations of less than 10 wt. %. Thus, in many microfiltration processes the filtered fluid portion is the desired product while the solids are discarded. Microfiltration may also be used to concentrate fluids in cases where the solid is the desired product, examples being processes for the concentration and recovery of proteins and bacteria from dilute solutions.

One problem often encountered during filtration and, in particular, microfiltration, is the formation of a compacted filter cake on the upstream surface of the filter membrane which may impede flow through the filter membrane or cause an increased pressure drop across the filter membrane. If the pressure drop across the filter membrane becomes too great, failure of the filter membrane by tearing may result. One method for dealing with filter cake formation on the upstream surface of the filter membrane is periodic introduction of a liquid stream to the filter membrane in the direction opposite the flow of permeate, thereby dislodging the particles forming the cake from the upstream surface of the filter membrane. This is commonly known as “backwashing” or “backflushing” (hereinafter “backflushing”). Processes incorporating cross-flow filters may also include backflushing of the filter membrane. Generally, the backflushing is carried out by reversing the flow across the filter membrane, thereby utilizing a portion of the permeate to dislodge particles present on the upstream surface of the filter membrane. Where the permeate used for backflushing contains small solid particles and dissolved ions which will be re-introduced to the dispersion on the upstream side of the filter membrane, backflushing in this manner is counterproductive to any washing process incorporated.

U.S. Pat. No. 3,630,360 to Davis et al. discloses a process for filtering fine suspensions of solids from liquids utilizing an apparatus containing a fine-mesh flexible filter membrane secured to the wide end of the funnel which is oriented for flow of fluid through the filter membrane and away from the wide end of the funnel. The process is preferably carried out at a low enough pressure drop to prevent clogging of the membrane by pulling of particles into its pores and also includes reversing the pressure differential across the filter membrane. The apparatus of Davis et al. also includes a receiver in fluid communication with the filter membrane for collecting the permeate and means for inducing the pressure differential across the filter membrane.

One application of filtration processes and, in particular, microfiltration processes, is the recovery of mesoporous crystalline particles, in particular, zeolite catalyst particles, from slurries. Zeolite based catalysts are commonly used in catalytic reforming processes.

U.S. Pat. No. 5,919,721 to Potter discloses using a microfilter containing a tubular filter membrane to wash and recover zeolite crystals, preferably those crystals less than about 0.5 μm in size, from a crystalline mother liquor or other aqueous liquid. In accordance with the process of Potter, a batch of zeolite crystals is slurried with water or an appropriate wash solution. Preferably, this slurry is concentrated with a microfilter and the crystals retained by the filter membrane are washed by adding make-up liquid. The steps of filtration and washing are carried out until the permeate pH is below a preselected value. Once the flow of make-up liquid is stopped, the slurry is concentrated to a preselected maximum final concentration.

International Publication Number WO 02/26380 discloses a process for the preparation of molecular sieve catalysts by microfiltration of a molecular sieve slurry. In accordance with this process, the slurry is introduced to the front end of at least one tubular microfilter channel containing pores through which the permeate stream passes outwardly to form a concentrated molecular sieve slurry. If a slurry of certain purity is desired, the process may include washing the slurry by addition of a wash fluid which is preferably water, an alcohol, or a mixture thereof. To determine if the slurry has been adequately washed, properties of the permeate such as conductivity can be monitored. The concentration and washing steps may be carried out continuously or sequentially. While the slurry is being concentrated, particles may congregate near the inside wall of the channel, resulting in concentration polarization within the slurry and an increase in pressure drop across the wall of the channel. In response, WO 02/26380 discloses “back washing”, or, “backflushing” the filter membrane by introducing wash fluid to the wall of the filter membrane from the downstream side of the filter membrane. The process of WO 02/26380 can also be carried out utilizing an apparatus containing multiple tubular microfiltration channels.

Processes and apparatus incorporating a plurality of filter membranes for parallel processing have also been described. U.S. Pat. No. 5,108,704 to Bowers et al. discloses a microfiltration apparatus containing a multiwell filtration apparatus which allows for collection of a filtrate stream from each well in a multiwell collection plate aligned with the filtration apparatus. The fluid to be filtered is sent by a common process fluid inlet to each of the filtration wells and a sample of the fluid is filtered by passage through the discrete filter membrane present in each filtration well.

U.S. Pat. No. 6,159,368 to Moring et al. is directed to a multi-well filtration apparatus utilizing multiple discrete filter elements contained in multiple microfiltration wells present in an array. A particular feature of the apparatus is separate collection of a filtrate stream from each well without cross-contamination among the multiple filtrate streams due, in large part, to the use of individual filter membranes within the wells rather than a common sheet of filter membrane. To carry out the process, a fluid sample is placed in each of a plurality of microfiltration wells and a vacuum is drawn along the path extending downward through the plane defined by a collection tray containing a plurality of collection wells corresponding to each microfiltration well.

U.S. Pat. No. 5,919,721 to Potter and International Publication Number WO 02/26380 each disclose processes incorporating multiple tubular filter membranes with each membrane functioning in accordance with the description set forth above.

Developments in combinatorial (i.e., high-throughput) chemistry have primarily been directed to synthesis of chemical compounds and evaluation of the activity of catalysts. Combinatorial protocols provide for synthesis of a greater number of materials without increasing the time necessary and also allow for evaluation of a greater number of catalysts in a reduced amount of time. For example, WO 96/11878 describes methods and apparatus for the parallel deposition, synthesis and screening of an array of diverse materials at known locations on one or more common substrates, U.S. Pat. No. 6,368,865 to Dahl et al. discloses a combinatorial process for performing catalytic reactions and U.S. Pat. No. 6,063,633 to Willson discloses processes and apparatus which permit synthesis and screening of multiple catalysts. It is envisioned that the present invention will provide those benefits associated with combinatorial chemistry in the context of a filtration operation (i.e., allow for treating a greater number of samples in less time). The parallel process of the present invention may also be incorporated in a process which includes other combinatorial protocols (i.e., synthesis of compounds or evaluation of catalysts).

### SUMMARY OF THE INVENTION

Briefly, therefore, the present invention is directed to a process for adjusting the composition of a dispersion comprising particulate matter and a fluid medium, the process comprising subjecting the dispersion to a separation process which produces a first fraction having a first concentration by weight of particulate matter to fluid medium and a second fraction having a second concentration by weight of particulate matter to fluid medium less than the first concentration; and sampling the first fraction intermittently over time during the separation process to form at least two first fraction samples.

The invention is further directed to a process for adjusting the composition of a dispersion comprising particulate matter and a fluid medium comprising exposing a surface of a filter membrane to a dispersion comprising particulate matter and a fluid medium, the dispersion having a first concentration of the particulate matter in the fluid medium; removing some of the fluid medium from the dispersion by causing fluid to flow through the membrane to form a permeate downstream of the membrane and a retentate upstream thereof, whereby the concentration of the particulate matter in the fluid medium of the retentate increases over time relative to the first concentration of the dispersion; and sampling the retentate intermittently over time to form at least two retentate samples, the at least two retentate samples having different concentrations of particulate matter in the fluid medium.

The invention is further directed to a process for adjusting the composition of a dispersion comprising particulate matter, the process comprising establishing a pressure differential across a filter membrane supported on a filtration head and separating a dispersion contained in a vessel from a permeate reception zone that is in fluid flow communication with the membrane, the membrane being immersed in the dispersion and the dispersion having particulate solids and ionic contaminants contained therein; during a filtration phase, causing liquid to flow through the membrane and into the permeate reception zone under the influence of the pressure differential, thereby forming a permeate in the reception zone and a retentate in the vessel; and during a backflushing phase, reversing the pressure differential across the membrane and causing a backflush liquid to flow through the filter membrane, the backflush liquid having a lower concentration of ions of the type contaminating the dispersion than the permeate stream.

The invention is further directed to a process for adjusting the composition of a dispersion comprising particulate matter, the process comprising introducing a filtration head into a vessel containing a dispersion comprising solid particles, the filtration head comprising a filter membrane carried by and in fluid flow communication with a conduit for removal of permeate; immersing the filter membrane in the dispersion; during a filtration phase, establishing a pressure differential across the filter membrane, thereby causing liquid to flow through the membrane to form a permeate stream downstream of the filter membrane and a retentate in the vessel; during a backflushing phase, reversing the pressure differential across the membrane and causing a backflush liquid to flow through the filter membrane; alternating the filtration phase and the backflushing phase through a series of cycles; and introducing a wash liquid into the retentate to fully or partially compensate for fluid removed from the vessel in the permeate.

The invention is further directed to a process for adjusting the composition of a dispersion comprising particulate matter, the process comprising contacting a filtration head comprising a filter membrane with a dispersion contained in a vessel comprising a fluid and particulate solids, the filtration head comprising a filter membrane and a permeate receiving enclosure in communication with the membrane on the opposite side of the membrane from the dispersion; during a filtration phase, establishing a pressure differential across the membrane causing liquid to flow through the membrane and into the permeate receiving enclosure under the influence of the pressure differential, thereby forming a permeate in the receiving enclosure while retaining particulate solids in a retentate formed in the vessel; and during a backflushing phase, reversing the pressure differential across the membrane and causing a backflush liquid to flow through the filter membrane to the interior of the vessel for removal of particulate solids from the membrane; and introducing a wash liquid into the retentate.

The invention is further directed to a process for adjusting the composition of a dispersion comprising particulate matter, the process comprising establishing a pressure differential across a filter membrane supported on a filtration head and separating a dispersion contained in a vessel from a permeate reception zone that is in fluid flow communication with the membrane, the membrane being immersed in the dispersion and the dispersion having particulate solids and ionic contaminants contained therein; during a filtration phase, causing liquid to flow through the membrane and into the permeate reception zone under the influence of the pressure differential, thereby forming a permeate in the reception zone and a retentate in the vessel; and measuring the conductivity of the retentate.

The invention is further directed to a process for adjusting the composition of a dispersion comprising particulate matter in a liquid medium, the process comprising exposing the surface of a filter membrane to a dispersion comprising liquid and particulate matter and causing liquid to flow through the filter membrane thereby forming a permeate stream downstream of the filter membrane relative to the flow of liquid therethrough and a retentate upstream of the filter membrane, whereby the liquid medium flows in more than one direction tangential to the face of the filter membrane.

The invention is further directed to a process for adjusting the composition of a dispersion comprising particulate matter in a liquid medium, the process comprising exposing the surface of a filter membrane supported on a filtration head to a dispersion comprising liquid and particulate matter, the filtration head comprising a permeate conduit and a backflush conduit, each in fluid communication with the filter membrane; causing liquid to flow through the filter membrane thereby forming a permeate stream downstream of the filter membrane relative to the flow of the liquid medium therethrough and a retentate upstream of the filter membrane, whereby the liquid medium flows in more than one direction tangential to the face of the filter membrane; and introducing a backflush liquid through the backflush conduit to the filter membrane in a backflushing direction.

The invention is further directed to a process for adjusting the composition of a dispersion comprising particulate matter in a liquid medium, the process comprising exposing the surface of a filter membrane supported on a filtration head to a dispersion comprising liquid and particulate matter; during a filtration phase, causing liquid to flow through the filter membrane, thereby forming a permeate stream downstream of the filter membrane relative to the flow of liquid therethrough and a retentate upstream of the filter membrane; and, during a backflushing phase, passing a liquid stream through the filter membrane in the direction opposite the flow of the permeate stream, the liquid stream having a lower concentration of ions contaminating the dispersion than the permeate stream passing through the membrane immediately prior to the backflushing phase.

The invention is further directed to a process for adjusting the composition of a dispersion comprising particulate matter in a liquid medium, the process comprising exposing the surface of a filter membrane to a dispersion comprising liquid and particulate matter; during a plurality of filtration phases, causing liquid to flow through the filter membrane thereby forming a permeate stream downstream of the filter membrane relative to the flow of liquid therethrough and a retentate upstream of the filter membrane; and, during a plurality of backflushing phases, passing a liquid through the filter membrane in the direction opposite the flow of the permeate stream, wherein the backflushing phases are controlled to achieve a desired rate of passage of liquid through the filter membrane.

The invention is further directed to a process for adjusting the composition of a dispersion comprising mesoporous crystalline particles in a liquid medium, the process comprising exposing the surface of a filter membrane to a dispersion comprising liquid and mesoporous crystalline particles and causing liquid to flow through the filter membrane, thereby forming a permeate stream substantially free of the mesoporous crystalline particles downstream of the filter membrane relative to the flow of liquid therethrough and a retentate upstream of the filter membrane, whereby the liquid medium flows in more than one direction tangential to the face of the filter membrane.

The present invention is further directed to a process for adjusting the composition of each of a plurality of dispersions comprising particulate matter and a fluid medium, the process comprising concurrently separating each dispersion of the plurality of dispersions into a first fraction having a first concentration by weight of particulate matter to fluid medium and a second fraction having a second concentration by weight of particulate matter to fluid medium less than the first concentration; and subjecting the first fraction of each dispersion of the plurality of dispersions to a wash process comprising introducing a wash liquid into the first fraction of each dispersion.

The invention is further directed to a process for adjusting the composition of each of a plurality of dispersions comprising particulate matter and a fluid medium, the process comprising concurrently separating each dispersion of the plurality of dispersions into a first fraction having a first concentration by weight of particulate matter to fluid medium and a second fraction having a second concentration by weight of particulate matter to fluid medium less than the first concentration; and sampling each of a plurality of the first fractions to form at least two separate first fraction samples.

The invention is further directed to a process for adjusting the composition of each of a plurality of dispersions comprising particulate matter and a fluid medium comprising concurrently exposing each of a plurality of filter membranes to a dispersion of the plurality of dispersions, the dispersion to which each of the plurality of membranes is exposed being separate from any dispersion to which any other of the plurality of membranes is exposed; removing some of the fluid medium from each of the plurality of dispersions by concurrently causing fluid to flow through each of the membranes to form a permeate downstream of each membrane and a retentate upstream thereof, thereby forming a plurality of separate permeates and a plurality of separate retentates; and sampling each of the plurality of retentates to form at least two separate retentate samples.

The invention is further directed to a process for adjusting the composition of each of a plurality of dispersions comprising particulate matter and a fluid medium, the process comprising concurrently exposing each of the plurality of filter membranes to a dispersion of the plurality of dispersions, the dispersion to which each of the plurality of membranes is exposed being separate from any dispersion to which any other of the plurality of membranes is exposed; concurrently causing fluid to flow through each of the membranes to form a permeate downstream of each membrane and a retentate upstream thereof, thereby forming a plurality of separate permeates and a plurality of separate retentates; and introducing a wash liquid into each of the separate retentates.

The present invention is further directed to an apparatus for separating each of a plurality of dispersions of particulate solids in fluid media to produce from each of the plurality of dispersions a first fraction and a second fraction wherein the particulate solids concentration in the first fraction exceeds the particulate solids concentration in the second fraction, the apparatus comprising a plurality of solids/liquid separators for separating each of the plurality of dispersions into a first fraction and a second fraction; a dispensing assembly adapted for delivery of each of a plurality of the dispersions to a solids/liquid separator of the plurality of solids/liquids separators that is separate from any other of the plurality of solids/liquid separators; and a second fraction removal assembly for removing from each of the solids/liquids separators the second fraction produced thereby, the removal assembly being configured for removing the second fraction produced by each of the plurality of solids/liquids separators separately from the second fraction produced by any other of the plurality of solids/liquids separators.

The invention is further directed to an apparatus for filtration of each of a plurality of dispersions of particulate solids in fluid media, the apparatus comprising a plurality of filter membranes each adapted for flow of fluid therethrough in a filtering direction to form a plurality of separate permeate streams; a plurality of permeate conduits, each of the permeate conduits being positioned to receive permeate from a membrane of the plurality of membranes that is separate from any of the plurality of membranes from which any other of the plurality of permeate conduits is positioned to receive permeate; and a plurality of backflush conduits for directing a backflushing liquid through the filter membranes, each of the backflush conduits being oriented for backflushing a membrane that is separate from any membrane which any other of the plurality of backflush conduits is oriented to backflush.

The invention is further directed to an apparatus adapted for filtration of a dispersion comprising particulate matter in a fluid medium, the apparatus comprising a filter membrane supported on a filtration head for flow of fluid through the filter membrane in a filtering direction to produce a permeate stream downstream of the filter membrane; a permeate conduit for receiving the permeate stream; and a backflush conduit for receiving a backflushing fluid and directing a backflushing fluid through the filter membrane in a backflushing direction.

The invention is further directed to an apparatus adapted for filtration of a dispersion comprising particulate matter in a liquid medium, the apparatus comprising a filter membrane supported on a filtration head for flow of liquid through the filter membrane in a filtering direction to produce a permeate stream downstream of the filter membrane; a permeate conduit for receiving the permeate stream; and electrodes for measuring the conductivity of the permeate stream.

The invention is further directed to an apparatus adapted for filtration of a dispersion comprising particulate matter in a liquid medium, the apparatus comprising a filter membrane supported on a filtration head for flow of liquid through the filter membrane in a filtering direction to produce a permeate stream downstream of the filter membrane; a permeate conduit for receiving the permeate stream; and a backflush conduit for receiving a backflushing fluid and directing a backflushing liquid through the filter membrane in a backflushing direction.

Other objects and features will be in part apparent and in part pointed out hereinafter.

### BRIEF DESCRIPTION OF THE DRAWINGS

FIG. 1 is a perspective view of one embodiment of a filtration head for use in accordance with the present invention.

FIG. 2A is a perspective view of the filtration head of FIG. 1 positioned within a vessel.

FIG. 2B is a sectional view of the filtration head shown in FIG. 2A.

FIG. 2C is a detailed view of a portion of FIG. 2B.

FIG. 2D is a detailed view of a portion of FIG. 2B.

FIG. 3A is a schematic view of apparatus of this invention incorporating a filtration head of a different embodiment than shown in FIG. 2A.

FIG. 3B is a detailed view of a portion of FIG. 3A.

FIG. 3C is a schematic view of apparatus of this invention incorporating a filtration head of a different embodiment than shown in FIG. 2A.

FIG. 3D is a detailed view of a portion of FIG. 3C.

FIG. 4A is a perspective view of one embodiment of a parallel filtration module for use in accordance with the present invention.

FIG. 4B is a perspective view of one embodiment of a parallel filtration module for use in accordance with the present invention.

FIG. 5 is a description of one embodiment of a parallel operation of the present invention.

FIG. 6A includes a graph of the flow rate through a filter membrane v. time.

FIG. 6B includes a graph of an optimization of backflushing for zeolite microfiltration.

Corresponding reference characters indicate corresponding parts throughout the drawings.

### DETAILED DESCRIPTION OF THE PREFERRED EMBODIMENTS

Described herein are novel liquid-solid separation processes for adjusting the composition of a dispersion or plurality of dispersions comprising particulate matter and a fluid medium. Generally, the dispersion or dispersions are separated into a plurality of fractions which typically include a first fraction having a first concentration of particulate matter and a second fraction having a second concentration of particulate matter. Typically the second concentration is lower than the first concentration. In accordance with the present invention, a plurality of dispersions may be separated into a plurality of fractions concurrently. In both processes for adjusting the composition of a single dispersion and a plurality of dispersions, the first fraction or fractions may be subjected to a wash process which comprises introducing a wash liquid into the first fraction. Any first fraction or first fractions may also be sampled over time to form a plurality of samples of the first fraction. Additionally or alternatively, samples may be taken of the second fraction, the first fraction after separation of wash liquid, the spent wash liquid, etc. Samples may be taken intermittently during the separation process, and may thus differ from one another with regard to solids content, soluble components, etc.

Further described herein are novel apparatus for use in liquid-solid separation processes for adjusting the composition of a dispersion or plurality of dispersions comprising particulate matter and a fluid medium. The novel apparatus of the present invention generally comprises one or more solid/liquid separators for separating a dispersion or plurality of dispersions into a plurality of fractions generally including a first fraction and second fraction. The apparatus may further include dispensing assemblies for delivering a dispersion or plurality of dispersions to one or more solid/liquid separators. Means for removing a portion of a second fraction or fractions from the solid/liquid separator or separators may also be included in the apparatus. These means for second fraction removal may be configured for removal of second fraction produced by each of a solid/liquid separator separately from the second fraction produced by any other of the solid/liquid separators.

In particular, a liquid-solid separation process for adjusting the composition of a dispersion comprising particulate matter in a fluid medium utilizing a novel filtration apparatus comprising a filter membrane has been discovered. This process is useful in treating dispersions containing particulate matter at a greater concentration than can generally be treated using prior art methods. The design of the novel filtration apparatus allows for treating such mixtures while utilizing a very small surface area of filter membrane.

In accordance with the present invention, a novel liquid-solid separation process for adjusting the composition of a plurality of dispersions comprising particulate matter in a fluid medium utilizing a novel filtration apparatus comprising a plurality of filter membranes has been discovered. The process for adjusting the composition of a plurality of dispersions may be carried out such that the dispersions are treated concurrently. This parallel process may be incorporated in overall process workflows and combinatorial protocols in which a filtration step is necessary or desirable.

The process of the present invention for adjusting the composition of a dispersion comprising particulate matter in a fluid medium is carried out by exposing the surface of a filter membrane to the dispersion and causing fluid to flow through the filter membrane. The filter membrane may be exposed to the dispersion to be treated by any of a number of methods including, for example, exposing the filter membrane to a flow of the dispersion or introducing the filter membrane to a vessel containing the dispersion. The flow of fluid through the filter membrane forms a permeate stream downstream of the filter membrane, relative to the direction of flow through the filter membrane, and a retentate upstream of the filter membrane, relative to the direction of flow through the filter membrane. Typically, the process of the present invention is used to treat dispersions comprising a liquid medium and, accordingly, liquid flows through the filter membrane. In accordance with the present invention, the dispersion, and more particularly the fluid medium within which the solids are dispersed, exhibits flow in more than one direction tangential to the face of the filter membrane. The process of the present invention may further include introducing a wash liquid to the retentate and may also include agitation of the dispersion. In addition, a backflush liquid may be introduced to the filter membrane in a direction opposite the flow of the permeate stream through the membrane. In one embodiment, the process of the present invention is used to treat a dispersion comprising mesoporous crystalline particles.

Various embodiments of the process of the present invention incorporating any or all of these features and one or more additional features will be discussed hereinafter.

Dispersions treated in accordance with the present invention are generally at least two-phase systems where one phase comprises finely divided particles comprising a disperse, or, internal phase distributed throughout a bulk substance comprising the continuous, or, external phase. The dispersion to be treated may be uniform or non-uniform. These two-phase systems may be described as “internal phase-external phase”. For example, a dispersion wherein a solid is distributed throughout a liquid may be referred to as a “solid-liquid” dispersion. Examples of dispersions which may be treated in accordance with the present invention include “solid-liquid”, “solid-gas”, and “liquid-gas”. Preferably, the bulk substance comprising the continuous phase of the dispersion is a fluid or liquid medium comprising at least one of a gas phase component or a liquid phase component. Typically, a suitable liquid medium will exhibit a viscosity of no greater than about 5 centipoise. Preferably, the viscosity of the liquid medium is from about 1 to about 5 centipoise and, more preferably, from about 2 to about 4 centipoise.

Composition, configuration and properties of the particulate matter in the dispersion to be treated are not narrowly critical and may generally be characterized in terms of pore size. Microporous particulate matter generally have average pore sizes ranging from about 5 or less to about 20 angstroms while mesoporous particles generally have average pore sizes ranging from about 20 to about 500 angstroms. The particulate matter may include zeolite materials.

Examples of suitable liquids which may comprise the fluid medium include water, methanol, xylene and acetone. In accordance with the process of the present invention, suitable gases which may comprise the continuous phase and include, for example, air and combustion gas. Typically, the continuous phase comprises a substantial portion of the permeate stream.

The composition of the dispersion treated in accordance with the present invention is adjusted by causing fluid, typically a portion of a liquid medium comprising the dispersion, to flow through the filter membrane to form a permeate stream downstream of the filter membrane and a retentate upstream of the filter membrane. Flow through the filter membrane is driven by a pressure differential across the filter membrane. This pressure differential can be induced by operating at atmospheric pressure upstream of the filter membrane and at a lower pressure downstream of the filter membrane (i.e., vacuum filtration) or by operating at atmospheric pressure downstream of the filter membrane and higher pressure upstream of the filter membrane (i.e., pressure filtration).

In accordance with the present invention, the permeate flows into a permeate reception zone in fluid flow communication with the filter membrane.

In the case of vacuum filtration, the pressure differential across the filter membrane during a filtration phase is less than about 14.5 psi. Preferably, the pressure differential across the filter membrane is from about 1 to about 14.5 psi, more preferably from about 5 to about 14.5 psi and, still more preferably, from about 10 to about 14.5 psi. In one embodiment, the pressure differential across the filter membrane is maintained substantially constant during a filtration phase.

In the case of pressure filtration, the maximum allowable pressure differential across the filter membrane is dictated by numerous factors including, for example, the type of filter membrane, the surface area of filter membrane exposed to the pressure differential and any support structure for the membrane incorporated into the apparatus. Thus, the maximum allowable pressure differential for pressure filtration depends on materials of construction and application of known design principles for handling pressurized fluids.

Care must be taken to avoid inducing a pressure differential across the filter membrane which may increase the rate of flow through the membrane to a level which may cause excessive fouling of the filter membrane due to clogging of the pores of the filter membrane by particulate matter. It is especially important to avoid creating a pressure differential that would cause the solid particles to become so firmly lodged in the pores of the membrane so that they become resistant to removal by backflushing.

The apparatus for use in the present invention typically includes a filter membrane supported on a filtration head which is adapted for placement such that the filter membrane is at least partially immersed in the dispersion to be filtered and for flow of fluid through the filter membrane in a filtering direction to form the permeate stream. The apparatus further includes a permeate conduit and/or a receiver for the permeate in fluid flow communication with the downstream face of the filter membrane; and further includes a backflush conduit for delivering a backflush fluid to the downstream face of the filter membrane and causing the fluid to flow in the reverse direction through the membrane for removing filter cake from the upstream face of the membrane and/or dislodging particles from the membrane pores. Optionally, the filter membrane may be disposed in a wall or at a terminus of an enclosed housing, in which case the permeate conduit and backflush conduit may be contained within the housing.

The apparatus may also include electrodes for measuring the conductivity of the permeate or retentate. In an embodiment including a housing, the conductivity of the permeate may be monitored by electrodes which are incorporated into the housing near the filter membrane. In such an embodiment, each of the permeate and backflush conduits is preferably located downstream of the electrodes with respect to permeate flow to avoid disruption of the conductivity measurement. In an embodiment in which the permeate conduit is not disposed within a housing, electrodes may be positioned downstream of the filter membrane such that the permeate stream will come into contact with the electrodes. If the conductivity of the retentate is to be monitored, the apparatus may further include electrodes incorporated into a probe tip adapted for removing a sample of the retentate and causing the sample to flow past the electrodes.

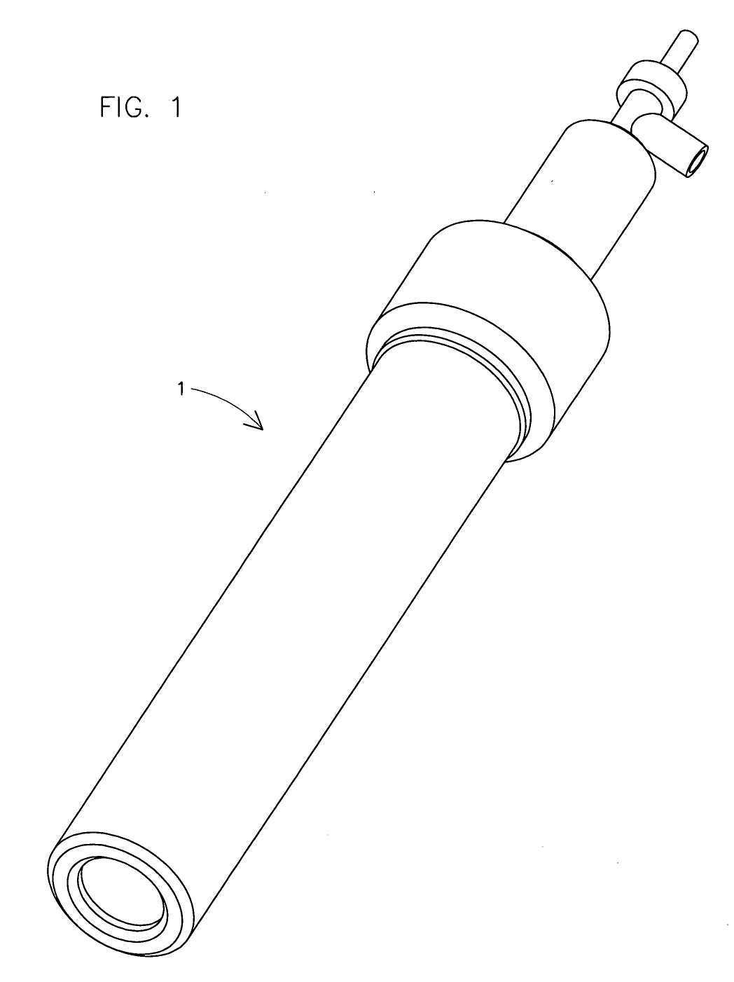

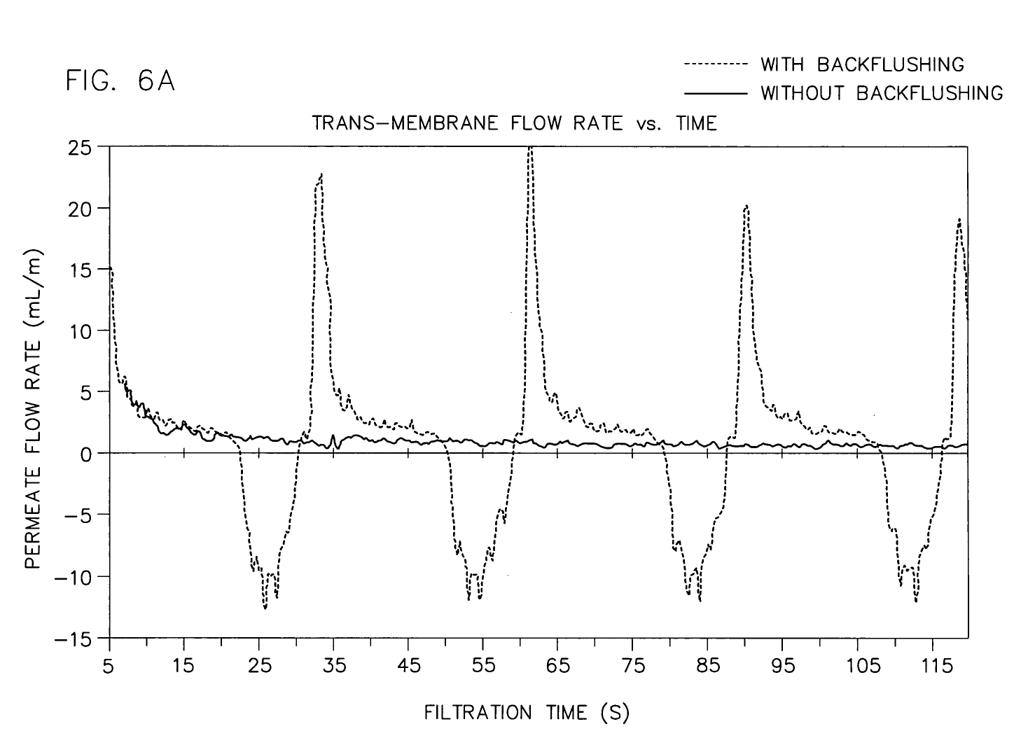

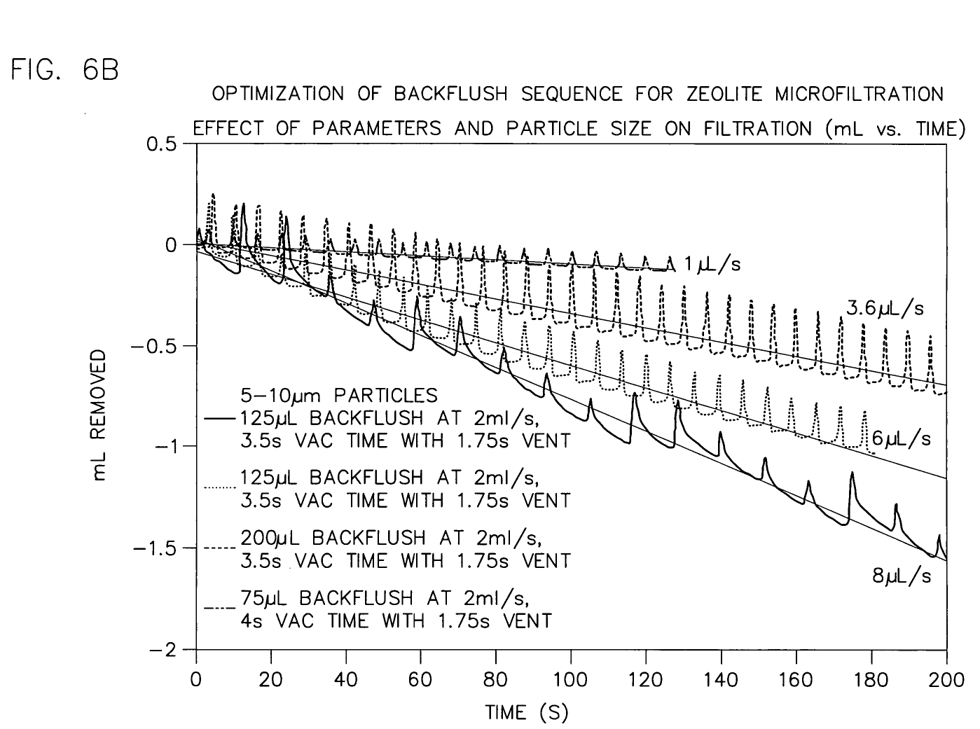

Various other features of one or more embodiments of the apparatus of the present invention will be discussed hereinafter with reference to FIGS. 1-6B.

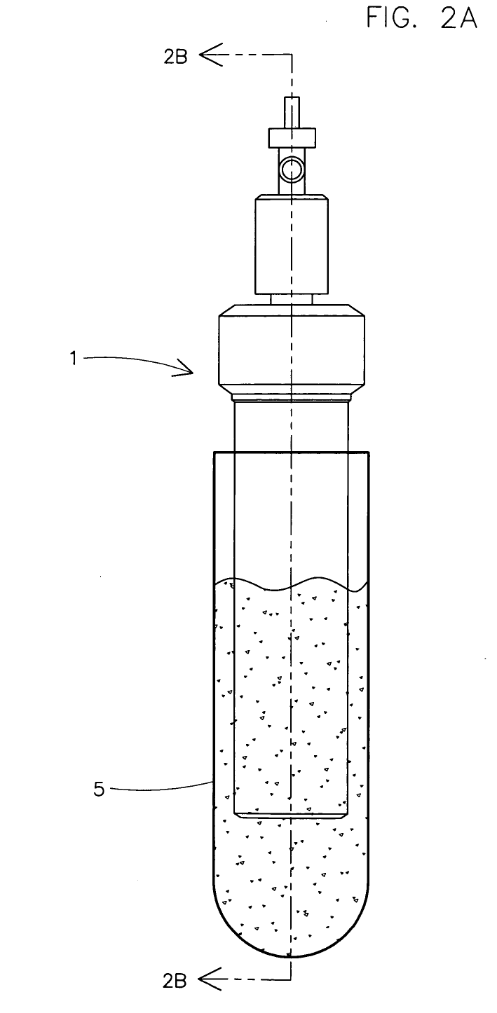

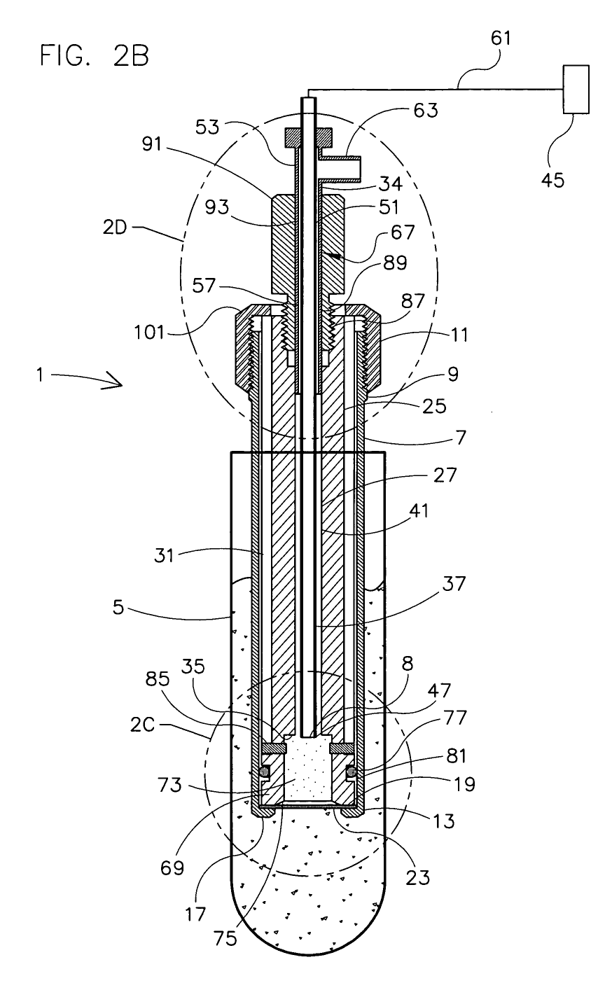

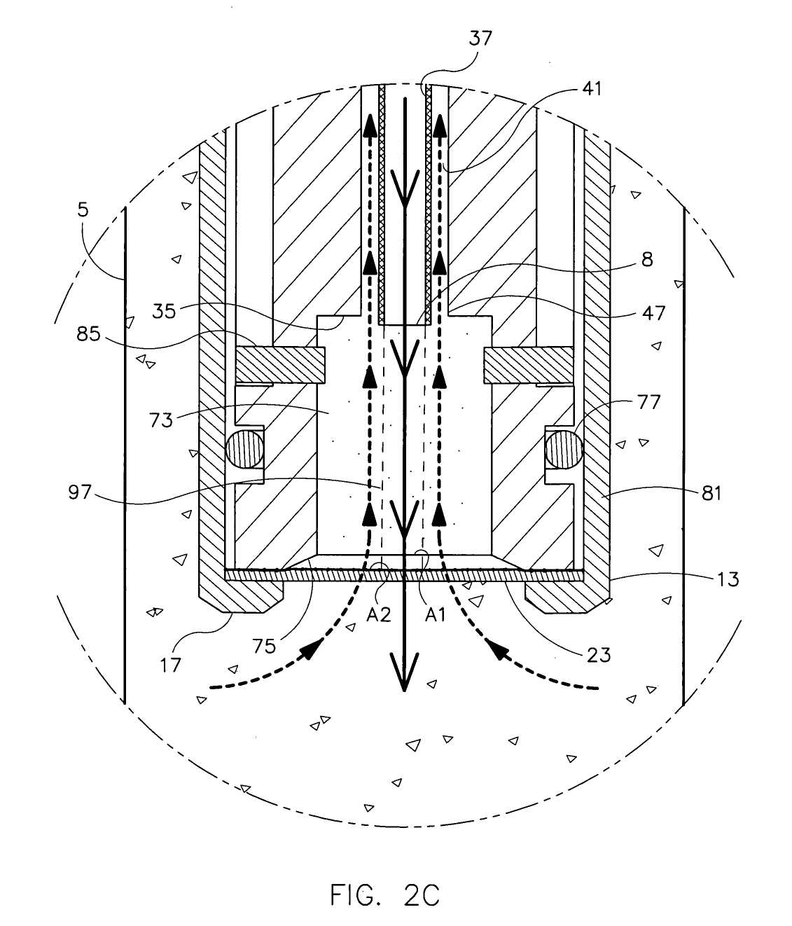

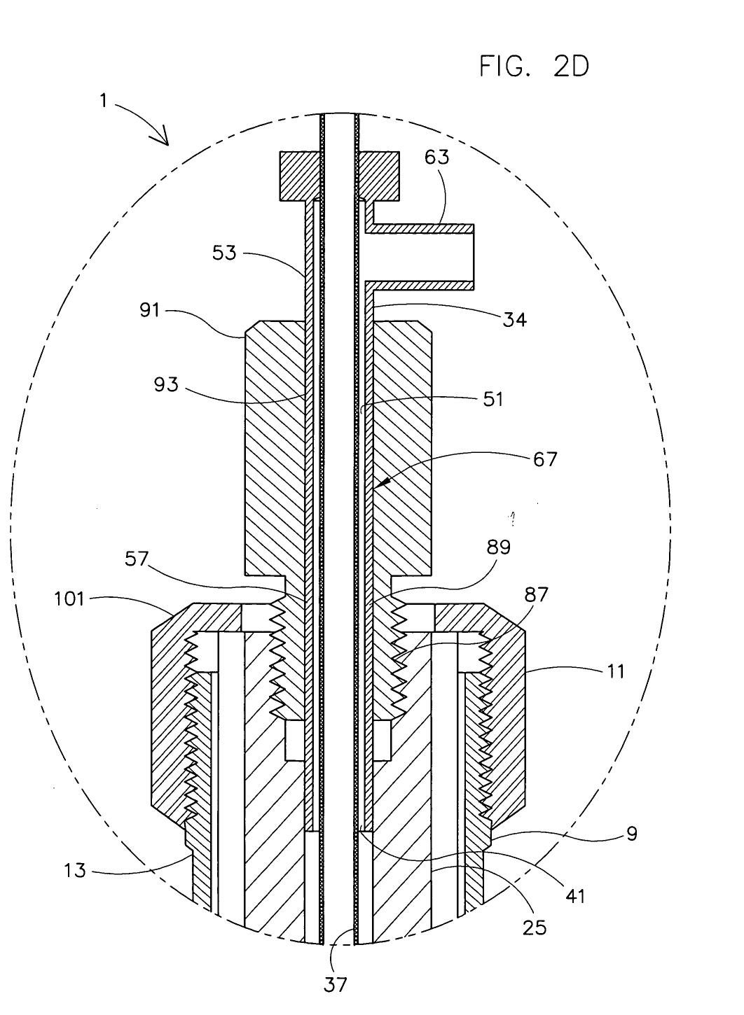

FIGS. 1, 2A, 2B, and 2C illustrate one embodiment of the filtration head 1 adapted for use in the process of the present invention. Referring to FIGS. 2B and 2C in particular, the head is shown immersed in a dispersion comprising particulate matter contained in a vessel 5. In this embodiment, head 2 comprises a tubular housing 7 suspended at its proximal (upper) end 9 by threaded engagement with a cap 11 that is in turn supported in any convenient manner, e.g., in a manner as further described hereinbelow. At its distal (lower) end 13, housing 7 comprises a flange 17, preferably integral with the housing, projecting radially inward from the tubular wall of the housing 7. A perforate or macroporous disc shaped membrane support 19 is positioned within the housing 7 in contact around its periphery with the interior face of flange 17, and a circular filter membrane 23 is essentially coextensive with the support and in contact across its exterior (upstream) face with the face of support 19 opposite the face of the support that is in contact with flange 17. A cylindric fluid transport block 25 is positioned substantially concentrically within the housing 7 and comprises an axial bore 27 that is also substantially concentric with the housing 7 and the block 25. Preferably, the outside radial dimension of the block 25 is only slightly less than the inside radial dimension of the housing 7 to ensure substantial concentricity between the housing 7 and the block. The outer surface of the block may be formed with axial grooves or recesses 31 to reduce the amount of block material and to provide pathways for wires in contact with the integrated electrodes 85. The distal (lower) end of the block 25 is formed with a countersink 35. A tubular backflush conduit 37 is positioned concentrically within transport block bore 27. The exterior surface of the backflush conduit is spaced radially inward from the interior surface defining the bore 27, thus forming an annular space constituting a permeate conduit 41. Backflush conduit 37 has an outlet at its distal (lower) end in proximity to the interior (downstream) face of the membrane 23. The backflush conduit 37 projects up from the proximal end of fluid transport block 25 and housing 7 and is in fluid flow communication with a suitable source 45 of backflush fluid. Permeate conduit 41 has an inlet at its distal end 47 in proximity to the interior, i.e., downstream, face of the membrane 23, and an outlet at its proximal end where it communicates with an annular permeate passage 51 defined by the exterior surface of the backflush conduit 37 and an interior surface of a concentric permeate transfer tube 53 surrounding the backflush conduit 37. The permeate transfer tube 53 and backflush conduit 37 extend out of the proximal end of block 25 through a central opening 57 in the cap 11. Permeate flows through the permeate passage 51 through a tee connection and to a suitable location.

In one embodiment, backflush fluid is supplied from source 45 to the backflush conduit 37 via a fluid flow line 61 and a tee connection 63 which penetrates the permeate transfer tube 53 and conduit 37 for flow of backflush fluid into the conduit 37. The tee connection 63 holds the conduit 37 and permeate transfer tube 53 in fixed position relative to one another without blocking the flow of permeate through the permeate transfer tube, in effect creating what may be referred to as a double-wall tube 67.

A retainer comprising a retaining ring 69 is positioned concentrically within the housing 7 between the membrane 23 and the distal end of the fluid transport block 25. The inside diameter of the ring 69 is preferably substantially larger than the outside diameter of the backflush conduit 37, and more preferably about the same diameter as the countersink 35 in the distal end of the fluid transport block 25, thereby defining a fluid flow chamber 73 above the filter membrane 23. A countersink 75 in the lower end of the ring 69 increases the area of the filter membrane 23 exposed to permeate flow. A sealing element 77 (e.g., an O-ring seal) is received in a circumferential groove 81 in an outer surface of the ring 69 for sealing against passage of permeate or backflush fluid into the space between block 25 and the interior surface of housing 7. Conductivity electrodes 85 located between the distal end of block 25 and the retaining ring 69 are adapted to contact permeate flowing away from the downstream surface of membrane 23 and to provide an indication of conductivity and soluble ion content of the permeate.

In the illustrated embodiment (FIG. 2B), the proximal (upper) end of fluid transfer block 25 has a counterbore 87 that is tapped to receive the threaded stem 89 of a rotatable adjustment knob 91. The knob 91 has a central bore 93 generally co-axial with the bore 27 in the block 25. The double-wall tube 67 extends through the bore 93 and is suitably affixed (e.g., press fitted or welded) to the knob 91 so that double-wall tube 67 rotates in unison with the knob. The arrangement is such that rotation of the knob 91 relative to the block 25 causes the double-wall tube 67 to move axially with respect to the housing 7 and block 25, thereby to adjust the spacing between the distal end of backflush conduit 37 and the interior (downstream) face of membrane 23. Preferably, the dimensions of backflush conduit 37, counterbore 87 and knob 91 are such that the space or gap between the distal end of backflush conduit 37 and the interior face of the membrane 23 can be adjusted to between about 10 mm and about 15 mm. With reference to FIG. 2C, by maintaining a proper gap between the backflush conduit 37 and the membrane 23, resistance against lateral flow across the boundary 97 between the area A1 defined by the projection of the backflush conduit 37 onto the membrane surface and the area A2 outside that projection is sufficiently high to prevent substantial contamination of backflush fluid with permeate, but sufficiently low to allow the backflush fluid to reach and penetrate the entire interior surface of the membrane.

With reference to FIG. 2D, the filtration head 1 is conveniently supported on the double-wall tube 67 via the knob 91, fluid transport block 25 and cap 11. A radially inwardly oriented flange 101 on cap 11 engages the proximal (upper) end of the fluid transport block 25. The cap 11 may be screwed tight on the housing 7 draw the cap down against the block 25 and establish a snug fit between all contacting elements of the filtration head assembly.

In use, backflush fluid is delivered under pressure from fluid source 45 via flow line 61 to the backflush conduit 37. The fluid exits the conduit 37 and flows through the filter membrane 23 to remove particles collected on the exterior (lower) face of the filter membrane to prevent clogging of the filter. Simultaneously, a suitable vacuum connected to the permeate passage 51 to draw permeate from the vessel 5 through the filter membrane 23 and into the fluid flow chamber 73 for flow up into the permeate conduit 41 and permeate passage 51. As filtered permeate contacts the electrodes 85, an electric signal is generated and processed by a suitable processor (not shown) to provide an indication of conductivity and soluble ion content of the permeate.

Suitable materials of construction for the housing 25 of the filtration head depicted in FIG. 2B include stainless steel or synthetic materials, for example, polyvinylidene fluoride or teflon. Preferably, the housing will be constructed of stainless steel as it is the most chemically inert of the suitable materials. The other portions of the apparatus will be constructed of one or more of the synthetic materials so as to avoid interference with the electrodes.

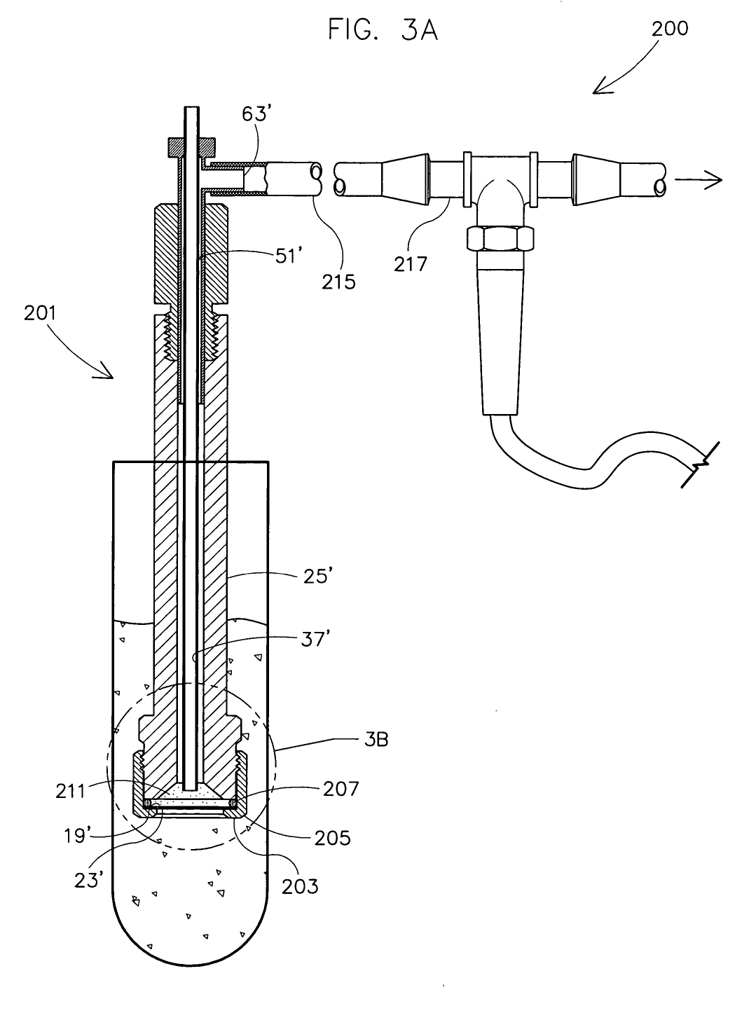

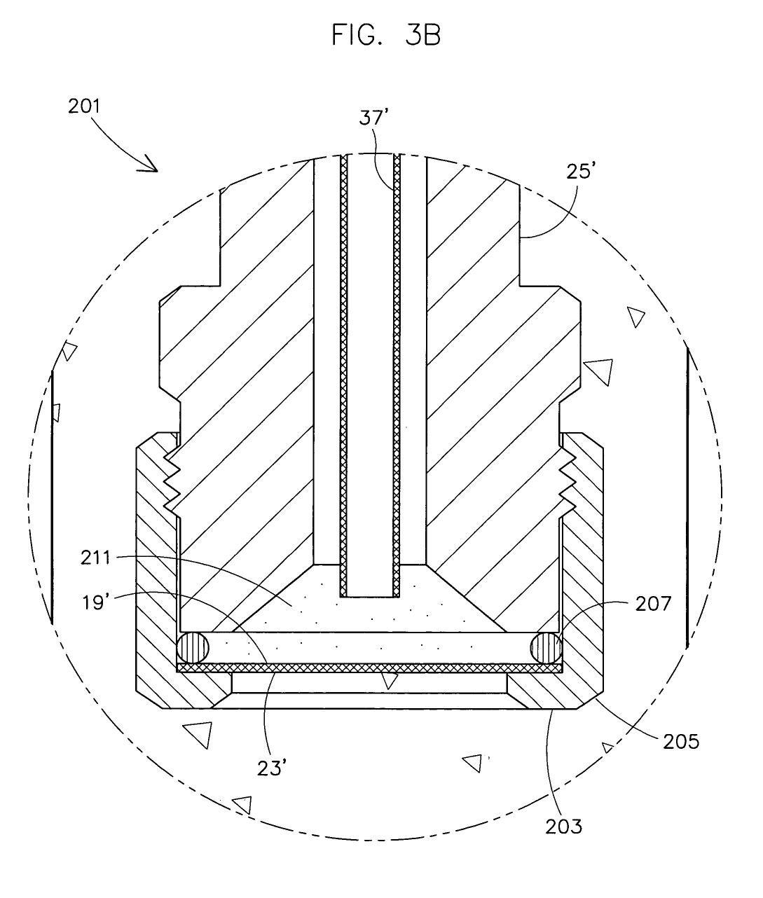

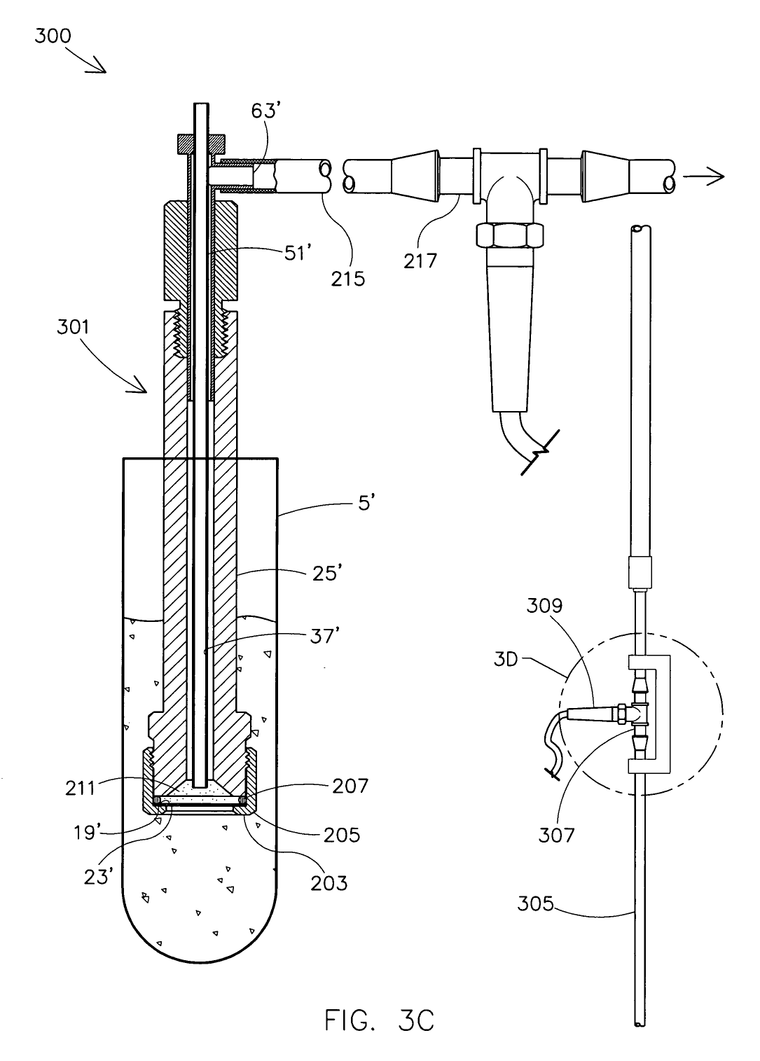

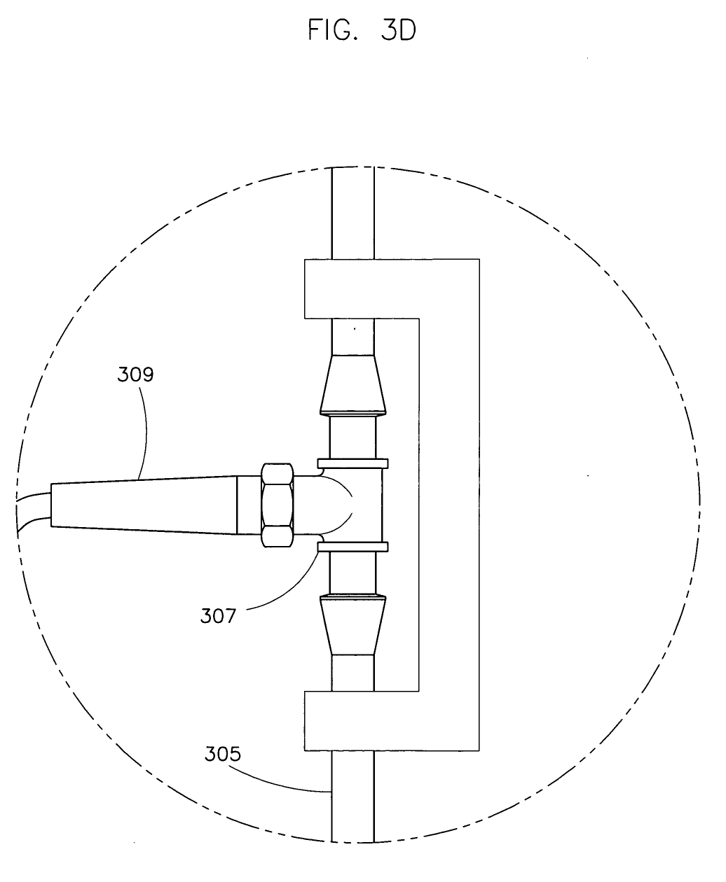

FIG. 3A illustrates a second embodiment of apparatus of this invention, generally designated 200. This apparatus comprises a filtration head of this invention, generally designated 201. The head is similar to the filtration head 1 of FIG. 2B (corresponding parts being given the same reference numbers but with a prime designation), but the head 201 does not include a housing for the fluid transport block 25′, or a cap at the proximal end of the transport block, or a retainer between the distal end of the transport block and the filter membrane 23′. Instead, a retaining cap 203 having an inwardly extending flange 205 at its lower end is threaded on the lower end of the fluid transport block 25′ into a position in which the flange 205 underlies the filter support 19′ and membrane 23′ and holds them snugly in place. A sealing element 207 (e.g., an O-ring seal) between an end face of the fluid transport block 25′ and the filter membrane 23′ seals against the cap 203 to prevent leakage. As shown in FIGS. 3A and 3B, the distal (lower) end of the block 25′ is preferably formed with a conical countersink 211, and the backflush conduit 37′ extends down into the countersink to a position spaced above the filter membrane 23′ a suitable distance, as described in the previous embodiment. The countersink 211 should be sufficiently large to maximize the area of the filter membrane 23′ exposed to the flow of permeate.

In the embodiment of FIG. 3A, the tee connection 63′ communicates with annular permeate passage 51′ and permeate flows from tee 63′ through a fluid flow line 215 to a fitting 217 which contains electrodes (not shown) for measuring the conductivity of the permeate. The apparatus depicted in FIG. 2B and FIG. 3A may be constructed of materials including stainless steel or synthetic materials, for example, polyvinylidene fluoride or teflon. In a preferred embodiment the filtration head is constructed of stainless steel since this material is the most chemically inert of those suitable for the construction.

FIG. 3C illustrates a third embodiment of apparatus of this invention, generally designated 300, in which the conductivity of the retentate rather than permeate is measured. Apparatus 300 comprises a filtration head generally designated 301, substantially identical to filtration head 201 described in FIG. 3A (corresponding parts being given the same reference numbers and with a prime designation with reference to those parts included in FIG. 3A). In this embodiment, apparatus 300 includes a liquid head 305 remote from the filtration head 301 itself and adapted for placement within the vessel 5′ such that the liquid head 305 may be used to aspirate a sample of retentate from the vessel 5′. The sample of retentate taken flows within the liquid head 305 to a tee 307 formed by a flow-through sensor 309 containing electrodes. The apparatus 300 of FIG. 3C may be constructed of the same materials suitable for the embodiment depicted in FIG. 3A and in view of the same considerations discussed above with respect to the materials of construction.

In accordance with the process of the invention, the filter membrane (e.g., 23 and 23′) is exposed to a dispersion, e.g., by immersing the membrane in a solid in liquid dispersion within a vessel or conduit, and a pressure differential is established across the filter membrane, preferably by establishing a partial vacuum on the downstream side of the membrane. As noted, the filtration head (e.g., 1, 201, and 301) may be used in either pressure filtration, typically with the downstream side of the membrane at atmospheric pressure and the upstream side above atmospheric pressure, or in vacuum filtration where the downstream side is at reduced pressure. In applications of the filtration method in parallel processing for combinatorial experimentation in the preparation and recovery of solid products such as precipitated zeolites, vacuum filtration is preferred to allow filtration of solids produced in open reaction vessels.

In the course of membrane filtration of a dispersion of solid particulates, the progressive buildup of filtered solids may generate a filter cake of depth sufficient to significantly increase the pressure drop between the bulk retentate and the permeate (downstream) side of the membrane and/or the membrane may become progressively blinded by solid particles lodged in the membrane pores. In either case, the membrane is preferably backflushed periodically by passage of liquid through the membrane in the reverse direction, i.e., from the downstream side to the upstream side. Backflushing disperses the filter cake in the retentate and dislodges solid particulates that may be blinding the pores. Upon resumption of normal filtration, operation proceeds at a lower, satisfactory pressure drop until the buildup of solids again causes the pressure drop to rise to a level at which a further backflush is indicated. The filtration operation progresses in this manner through a series of filtration cycles comprising alternating periods of filtration and backflushing. In subsequent discussion herein, the forward flow period of the filtration cycle is referred to as the filtration phase, and the backflush period of the cycle is referred to as the backflush phase.

In certain microfiltration operations, e.g., in the filtration of mesoporous or microporous materials such as zeolites obtained from hydrothermal synthesis, the aqueous liquid external phase is significantly contaminated with dissolved salts or other ionic species. Generally, it is desirable to produce a retentate, and ultimately a dried solid product, in which the contamination with soluble ionic species is reduced to some target maximum. To achieve this result, the retentate is subjected to a washing operation in which a wash liquid is introduced into a vessel, conduit or chamber containing retentate upstream of the filter membrane. The wash liquid has a concentration of the undesired ionic species lower than that of the retentate, and preferably is substantially free of the undesired species. Thus, the cycle of operation of the filter may be divided among a filtration phase, a backflush phase and a dilution phase. Alternatively, the wash liquid may be introduced continuously or intermittently during the filtration phase.

Because the backflush liquid also dilutes the retentate external phase, it is also preferred that the backflush liquid have a concentration of the undesired ionic species lower than that of the retentate, more preferably that it is substantially free of the undesired species.

In accordance with the present invention the surface of the filter membrane is exposed to the dispersion by introducing the filter membrane to the dispersion such that the filter membrane is immersed in the dispersion. The filter membrane may be introduced to a dispersion which is primarily stationary or which exhibits flow with reference to the filter membrane. Rather than flowing in a single direction parallel to the membrane as in a conventional tubular membrane filter, the dispersion, and in particular the fluid medium comprising the external phase thereof, flows normal or obliquely toward the membrane surface, is diverted by impingement on the membrane surface, and spreads out in multiple directions, typically in all directions, tangential to the face of the membrane.

The dispersion to be treated in accordance with the present invention may be contained within a vessel and the filter membrane may be exposed to the dispersion by movement of the filter membrane in the direction of the vessel or by movement of the vessel in the direction of the filter membrane until the filter membrane is immersed in the dispersion. The filter membrane may be exposed to a dispersion contained within a vessel by movement of a filtration head on which the filter membrane is supported or by movement of the vessel containing the dispersion until the filter membrane is immersed in the dispersion. Thus, when the dispersion is contained within a vessel and a filter membrane supported on a filtration head is introduced thereto, the filter membrane will be situated within the vessel so that it is immersed in the dispersion above the bottom of the vessel.

With references to the Figs. described above, a filtration head (e.g., 1, 201, and 301) supporting a filter membrane (e.g., 23 and 23′) and adapted for use in accordance with the present invention may be placed within the space defined by the vessel containing the dispersion such that the wetted surface area of the filter membrane comprises from about 10 to about 80% of the overall wetted surface area of the filtration head. Typically, the wetted surface area of the filter membrane comprises from about 25 to about 65% of the overall wetted surface area of the filtration head, and more typically from about 45 to about 55%. The filtration head is preferably adapted for placement in the vessel so that the ratio of the wetted surface area of the filter membrane to the overall wetted surface area of the filtration head is greater than about 2:1, more preferably greater than about 10:1 and, still more preferably, greater than about 25:1. Preferably, the ratio of the wetted surface area of the filter membrane to the overall wetted surface area of the filtration head is from about 2:1 to about 50:1, more preferably from about 10:1 to about 40:1.

Suitable vessels for containing dispersions to be treated in accordance with the present invention generally may be constructed of materials selected from the group consisting of metal, glass or plastic, for example, glass, polycarbonate, polyethylene and stainless steel. The vessels may be individual, exhibit some structural integration (e.g., a monolithic block or glass vessels supported by a monolithic block).

Selection of the filter membrane to be used is affected by considerations which include the composition of the dispersion to be treated (e.g., the size of any particulate matter present in the dispersion), the nature of fluid or liquid medium in which the particulate matter is dispersed, and the desired composition of the retentate. Those skilled in the art can routinely identify appropriate membranes based on available data on materials of construction, i.e., corrosion characteristics, hardness, other mechanical properties, etc., data on pore size distributions of commercially available membrane materials, the particle size distribution, particle configuration, and other properties of the dispersed matter, and the identity, density, viscosity, volatility and corrosion characteristics of the liquid medium.

Generally the filter membrane is selected such that at least about 60% of the particulate matter present in the dispersion has a particle size greater than the average pore size of the filter membrane, thereby being retained upstream of the filter membrane. Preferably, the filter membrane is selected such that from about 60 to about 80% of the particulate matter present in the dispersion has a particle size greater than the pore size of the filter membrane, more preferably from about 65 to about 75% of the particulate matter present in the dispersion has a particle size greater than the pore size of the filter membrane.

In accordance with the present invention, the filter membrane is preferably constructed of a permeable or semi-permeable material which is substantially uniformly porous. Suitable materials of construction include, for example, cellulose acetate, polyvinylidene fluoride, polytetra-fluoroethylene, or polycarbonate.

A filter membrane suitable for use in the present invention generally has an average effective pore size of from about 0.10 to about 3.0 μm. Preferably, the average effective pore size of the filter membrane used in the present invention is from about 0.10 to about 0.70 μm and, more preferably, from about 0.20 to about 0.45 μm.

Typically, the filter membrane will have a porosity of greater than about 50%. Preferably, the filter membrane will have a porosity of from about 50 to about 90%, more preferably from about 60 to about 80% and, still more preferably from about 70 to about 75%.

A filter membrane suitable for use in the present invention generally has an extractable water measurement less than about 5.0%. Typically, the filter membrane has an extractable water measurement of less than about 4.0%, more typically less than about 3.0%, still more typically, less than about 2.0% and, even more typically, less than about 1.0%. Preferably, the filter membrane has an extractable water measurement of from about 0.1% to about 5.0%, more preferably from about 0.5 to about 5%, still more preferably, from about 1.0 to about 4.0% or from about 2 to about 3%.

One advantage of the novel filtration apparatus of the present invention is the interchangeability of the filter membrane. That is, the filter membranes are easily removable and a filtration head may be used to support filter membranes constructed of different materials and of different dimensions. This feature provides for use of a single filtration head in many different applications.

Another advantage of the present invention is its adaptability for adjusting the composition of dispersions containing higher solids concentrations than can generally be treated by prior art methods. Typically, the initial concentration of particulate matter in a dispersion to be treated in accordance with the process of the present invention prior to any flow through the filter membrane is from about 1 to about 25% by weight. More typically, the initial concentration of particulate matter in the dispersion prior to any flow through the filter membrane is from about 5 to about 20% by weight.

In accordance with the present invention for treating a dispersion, a filter membrane is exposed to the dispersion and a pressure differential is established across the filter membrane to induce flow through the filter membrane during a filtration phase, thereby forming a permeate stream. Preferably, the pressure differential across the filter membrane is induced by establishing a partial vacuum on the downstream side of the membrane. The dispersion to be treated may comprise particulate matter and/or soluble ionic species and, typically, particulate matter forms a filter cake on the upstream surface of the filter membrane. This filter cake is removed by introducing a backflush liquid to the filter membrane in a backflushing direction opposite the flow of permeate during a backflushing phase. Cycles of alternating filtration and backflushing phases may be continued until a sufficient flow through the filter membrane has been observed. In the case of treating a dispersion contained within a vessel, flow through the filter membrane results in removal of liquid from the vessel which is monitored by the change in liquid level in the vessel.

In addition to one or more cycles of alternating filtration and backflushing phases, the process of the present invention may also include a dilution phase in which the dispersion is diluted at different times during the cycles of alternating filtration and backflushing phases. Dilution of the dispersion reduces the concentration of soluble ionic species in the dispersion and, therefore, including a dilution phase results in a retentate and permeate of improved purity.

Causing liquid to flow through the filter membrane produces a permeate stream downstream of the filter membrane and a retentate upstream of the filter membrane. During the filtration phase, the average flow or, flux, of permeate per unit area of filter membrane varies widely due to a variety of factors including, for example, the pore size of the filter membrane, the concentration of particulate matter present in the dispersion prior to any flow through the filter membrane and the size of any particulate matter present in the dispersion. Generally, the time integrated average flux of permeate per unit area of filter membrane is from about 0.10 to about 100 ml/cm²·min. Preferably, the average flux of permeate per unit area of filter membrane is from about 0.15 to about 10 ml/cm²·min, more preferably from about 0.20 to about 1 ml/cm²·min and, still more preferably, from about 0.4 to about 0.6 ml/cm²·min.

The permeate flux may also be characterized as a certain percentage of the flux through the filter membrane which may be obtained with a sample of water substantially free of particulate matter and ionic contaminants. This percentage varies with concentration of the dispersion and size of the particulate matter. Typically, permeate flux will be at least about 1% of an initial clean water flux. Typically, the permeate flux will be from about 1 to about 40% of the initial clean water flux. When the concentration of particulate matter in the dispersion is from about 1 to about 5% by weight, typically the permeate flux is from about 5 to about 40% of the initial clean water flux. When the concentration of particulate matter in the dispersion is from about 15 to about 25% by weight, typically the permeate flux is from about 1 to about 2.5% of the initial clean water flux.

In one embodiment, the initial flux of permeate per unit area of filter membrane during the first second of flow of liquid through the filter membrane begins is from about 20 to about 35 ml/cm²·min.

In accordance with the present invention, the dispersion to be treated may be agitated in order to enhance the flow of dispersion near the filter membrane. For example in parallel processing carried out in the course of a combinatorial synthesis scheme, the dispersion to be treated is contained within a vessel wherein it may be agitated using a magnetic stirrer. Any magnetic stirrer suitable for ensuring that the dispersion remains homogeneous and, accordingly, prevent any concentration gradient within the dispersion in the vessel, may be used to agitate the dispersion. Preferably, the means for agitation of the dispersion results in rotational flow, i.e., result in the formation of a vortex within the dispersion.

With reference to FIG. 2B, for example, the permeate produced by flow through the filter membrane flows within the permeate conduit 41 which includes a permeate inlet in fluid communication with the filter membrane and a permeate outlet in fluid communication with means for collecting the permeate stream, typically a vessel serving as a permeate reservoir. In one embodiment of the present invention, the means for collection of the permeate stream may be the permeate conduit itself which is adapted for recovery of a predetermined amount of permeate.

In a preferred embodiment, substantially all of the particulate solid remains upstream. However, as in other filtration operations, some particulate solid may pass through the filter membrane. It is generally understood that within a single filtration phase the concentration of particulate matter in the permeate decreases as filtration proceeds because a thin filter cake forms on the filter membrane, thereby assisting the filter membrane in filtering the dispersion. The concentration of particulate in the permeate generally decreases as the thickness of the filter cake increases during the course of a filtration phase. Over a series of cycles, or in some instances during the filtration phase of a single cycle, the concentration of particulate matter typically decreases in part due to depletion of particles of a size smaller than the pore size of the filter membrane, which have passed through the filter membrane and become part of the permeate stream. Accordingly, after a time substantially all the particulate matter remaining upstream of the filter membrane is of a particle size greater than the pore size of the filter membrane. Thus, after a certain time substantially all of the particulate matter remaining upstream of the filter membrane is unable to flow through the filter membrane, thereby reducing the concentration of particulate matter in the permeate.

Over the course of a series of filtration phases, it is generally understood that the fraction of finer particles in the retentate tends to decrease from cycle to cycle, with consequent decrease in concentration of particulate matter in the permeate. Accordingly, provided that significant attrition of particles is avoided (e.g., by modulating the vigor of agitation), the decrease in concentration of particulate matter in the permeate as observed over a single filtration cycle will be enhanced with each successive filtration cycle.

Generally, at least about 40% by weight of the particulate matter present in the dispersion remains in the retentate. Preferably, at least about 50% by weight of the particulate matter present in the dispersion remains in the retentate and, more preferably, at least about 60% by weight of the particulate matter present in the dispersion remains in the retentate.

Typically, from about 40 to about 80% by weight of the particulate matter present in the dispersion remains in the retentate, more typically from about 45 to about 75% by weight and, still more typically, from about 50 to about 70% by weight. In one embodiment, from about 45 to about 55% by weight of the particulate matter present in the dispersion remains in the retentate.

Dispersions which may be treated by the process of the present invention comprise particulate matter and may also include ionic materials distributed throughout. As noted, the process of the present invention may include addition of wash liquid aimed at controlling the concentration of ionic materials distributed throughout the dispersion upstream of the filter membrane and, accordingly, the concentration of ionic materials distributed throughout the permeate stream. As noted, the wash liquid may be added to the dispersion during a dilution phase intermittently or continuously during a filtration phase or intermittently during one or more cycles of alternating filtration and backflushing phases. Thus, the concentration of ionic materials present in the dispersion can be progressively reduced by repetitive removal of permeate and addition of wash liquid to the retentate.

Typically, the ratio of the rate of introduction of wash liquid to the flow through the filter membrane is less than 1.

In accordance with the present invention, the wash liquid preferably comprises the same liquid or liquid mixture that constitutes the external phase of the feed dispersion. Where the dispersion is aqueous, the liquid advantageously consists of deionized water. However, depending on the specific system involved, a wash liquid comprising a mixture of water and a water-miscible solvent, e.g., a low molecular weight alcohol, might be suitable in filtration of an aqueous dispersion. Where the liquid medium comprises an organic solvent such as xylene, toluene, a lower alcohol such as methanol or ethanol, a ketone such as methyl ethyl ketone, methyl isopropyl ketone, or methyl isobutyl ketone, an ester such as ethyl acetate or methyl propionate, etc., the wash liquid may have the same composition as the medium. However, where the retentate is contaminated with species of limited solubility in the external phase of the feed dispersion, the wash liquid may be selected or formulated to function as a solvent for the contaminants. For example, if a retentate is contaminated with inorganic ionic material, it is desirable to use a wash liquid that functions as a solvent for the ionic material. In some cases, for example, where the external phase comprises a lower alcohol, it may be feasible to formulate a wash fluid, such as an aqueous alcohol mixture, that is both a solvent for the ionic species and yet miscible with the external phase of the retentate.

In accordance with the present invention, the wash liquid is introduced to the dispersion via a wash conduit incorporated as part of the novel filtration apparatus. The wash conduit may also be incorporated as part of the novel filtration head.

If the initial concentration of particulate matter in the dispersion is greater than desired or greater than the concentration which may be treated in accordance with the present invention, wash liquid may be added prior to causing any flow through the filter membrane. Typically, the concentration of particulate matter in the dispersion prior to flow of liquid through the filter membrane is from about 1 to about 25% by weight. Preferably, the concentration of particulate matter in the dispersion prior to a single filtration cycle or the initial filtration cycle of a multi-cycle operation is from about 2.5 to about 15% by weight.

Generally, any wash liquid is added to reduce the concentration of particulate matter in the dispersion prior to a single filtration cycle or the initial filtration cycle of a multi-cycle operation to from about 1 to about 25% by weight, more preferably from about 2.5 to about 15% by weight.

In an embodiment in which the dispersion to be treated in accordance with the present invention is contained in a vessel, the initial concentration of particulate matter prior to causing any flow through the filter membrane may be controlled by monitoring and adjusting the level of dispersion in the vessel. Thus, if the level of dispersion in the vessel is below the desired level such that the concentration of particulate matter is greater than desired, the dispersion can be diluted with a suitable amount of wash liquid. Typically, the level of the dispersion in the vessel prior to flow through the membrane is from about 50 to about 75% of capacity of the vessel. In parallel processing for implementation of combinatorial synthesis, vessels used in accordance with the present invention generally have a capacity of from about 10 to about 25 ml. A vessel with a capacity of 25 ml will generally contain from about 15 to about 20 ml of dispersion prior to causing flow through the filter membrane.

As noted, the dispersion to be treated in accordance with the present invention may include ionic materials distributed throughout. In accordance with the present invention wash liquid may be added to the dispersion which, along with removal of permeate from the dispersion, reduces the concentration of ionic contaminants present in the dispersion, especially contaminants that are soluble in the liquid medium. The concentration of ionic materials present in the dispersion directly affects the conductivity of the dispersion and, thus, directly affects the conductivity of the retentate and permeate. Therefore, the concentration of ionic materials present in the dispersion may be indicated and/or determined by monitoring the conductivity of the retentate or permeate. The filtration apparatus for use in the present invention may include electrodes incorporated therein for this purpose.

With reference to FIG. 2B, the filtration head 1 comprises electrodes 85 located between the ring 69 and the lower end of the tubular housing 7. The electrodes are situated such that they may be used to monitor the conductivity of the permeate. With reference to FIG. 3A, the apparatus depicted therein includes a fitting 217 containing electrodes for measuring the conductivity of the permeate stream and in fluid flow communication with the permeate conduit. With reference to FIG. 3C, the apparatus depicted therein includes a flow through sensor 309 containing electrodes which is in fluid communication with a liquid head 307 used for removing a sample from the vessel 5′.

Prior to any flow through the filter membrane, the dispersion typically exhibits a conductivity of no greater than about 400,000 μSiemens/cm. Typically, the conductivity of the dispersion prior to any flow through the filter membrane is not greater than about 400,000 μSiemens/cm, typically from about 60,000 to about 400,000 μSiemens/cm.

Additionally or alternatively, the conductivity of the retentate may be monitored while flow through the filter membrane occurs and may also be monitored upon completion of a filtration phase. In either case, the conductivity of the retentate is monitored and wash liquid is added to the retentate to reduce the conductivity of the retentate to preferably less than about 100 μSiemens/cm over the course of a single filtration cycle or over the course of multiple filtration cycles, more preferably less than about 75 μSiemens/cm and, still more preferably, less than about 50 μSiemens/cm. Preferably, addition of the wash liquid reduces the conductivity of the retentate to from about 5 to about 80 μSiemens/cm, more preferably from about 10 to about 70 μSiemens/cm and, still more preferably, from about 10 to about 50 μSiemens/cm. Typically, upon completion of a dilution phase the conductivity of the retentate is from about 10 to about 40 μSiemens/cm.

When the dispersion is contained within a vessel, control of the concentration of particulate matter or ionic materials in the dispersion and, accordingly, the permeate stream produced, may also be carried out by addition of wash liquid to maintain the liquid level of the mixture in the vessel substantially constant.

One problem which may be observed during operation of the process of the present invention is the presence of particulate matter at or near the upstream surface of the filter membrane which may reduce the flow through the filter membrane and possibly cause fouling due to an increase in pressure differential across the membrane or clogging of the pores of the filter membrane by particulate matter. Thus, in accordance with the present invention, a backflush liquid may be introduced to the filter membrane in a backflushing direction opposite the direction of flow through the filter membrane, thereby removing particulate matter from the vicinity of the upstream surface of the filter membrane. The backflush liquid is therefore mixed with the retentate and the period of time during which backflush liquid is introduced to the filter membrane is referred to as a backflushing phase. In one embodiment, the concentration of ionic material, of the type present in the dispersion to be treated, is lower in the backflush liquid than in the retentate, thereby increasing the purity of the retentate and, accordingly, any permeate produced after the backflush liquid is introduced to the filter membrane. In one embodiment, the alternating filtration and backflushing cycles and dilution phases are continued until the conductivity of the retentate or permeate reaches a predetermined value. In a typical process, approximately 20 ml of dispersion is initially present in a vessel and cycles of alternating filtration and backflushing phases are carried out until approximately 10 ml of dispersion has been removed from the vessel. Typically, the cycles of alternating filtration and backflushing phases are continued for from about 10 to about 30 minutes.

During a backflushing phase, typically from about 75 to about 250 μl of backflush liquid is introduced to the filter membrane, more typically from about 100 to about 200 μl of backflush liquid is introduced to the filter membrane.

With reference to FIG. 2B, the backflush conduit 37 includes a backflush outlet in fluid communication with the filter membrane 23 and a backflush inlet in fluid communication with a source of backflushing liquid. In accordance with the present invention the source of backflushing liquid may be integrated within or remote from the filtration head 1. An apparatus in which the source of backflushing liquid is incorporated within the filtration head may be used in a process whereby a predetermined amount of backflush liquid is introduced to the filter membrane. Preferably, the backflush conduit 37 is concentrically disposed within the permeate passage defined by the permeate conduit 41 also shown in FIG. 2B. In an alternative embodiment, the permeate conduit may be concentrically disposed within the backflush conduit. In either case, the cross-sectional area of the permeate reception zone should be sufficient to ensure that pressure drop arising from permeate flow does not adversely affect the pressure differential across the membrane or the ability to control it.

Introduction of the backflush liquid to the filter membrane occurs by reversing the pressure differential across the filter membrane. This may be by either introducing the backflush liquid to the filter membrane by means of a pump or by inducing a vacuum upstream of the filter membrane. Since the pressure differential across the filter membrane during a backflushing phase is in the direction opposite that of a filtration phase, a backflushing phase and filtration phase are not normally concurrent. In addition, the apparatus for use in the present invention may include a valve for preventing permeate flow during a backflushing phase, thereby avoiding flow of backflush liquid within the permeate conduit.

In one embodiment, the backflush liquid is introduced to the filter membrane by means of a pumping device. This provides a greater pressure differential across the filter membrane in the backflushing direction than can be produced by inducing a vacuum upstream of the filter membrane. In one embodiment an elevated pressure downstream of the filter membrane is created by a syringe pump used to introduce the backflush liquid to the filter membrane in a backflushing direction.

Because the backflush fluid flux per unit membrane area is a function of the reverse pressure differential on backflush, it may in some instances be desirable to provide for delivering the backflush fluid at a significantly elevated pressure. For example where the filtration phase is effected by vacuum filtration from an open (atmospheric) vessel, where the maximum pressure differential is less than 14.5 psi, it may be advantageous to provide for pressure operation at a significantly higher pressure drop across the membrane during the backflush phase, e.g., by use of a syringe pump for delivery of backflush fluid. The area of backflush conduit outlet must be sufficient such that, at pressures which may be induced across the filter membrane in a backflushing direction, backflush liquid will be introduced to the entire surface of the filter membrane, thereby ensuring permeate flow across the entire membrane during a successive filtration phase. When the backflush conduit is concentrically disposed within the space defined by the permeate conduit, minimizing the cross-sectional area of backflush conduit, which is rendered feasible, e.g. by operation at a relatively high membrane pressure drop during the backflush phase allows for maximizing the annular space between the backflush conduit and permeate conduit. Thus, the area provided for flow of permeate may be maximized without increasing the overall size of the apparatus. In such applications, introducing backflush liquid to the filter membrane by a pumping device may be preferred since supplying the backflush liquid at the syringe pump outlet temperature allows backflush liquid to flow at a satisfactory rate through a backflush conduit of minimal cross-sectional area relative to the permeate conduit.

In accordance with the novel filtration apparatus of the present invention, the location of each of the permeate conduit and backflush conduit relative to the downstream surface of the filter membrane may be adjusted independently of the location of the other. Generally, it is desired that the conduits are arranged such that the inlet of the permeate conduit and outlet of the backflush conduit are as near as possible to the downstream surface of the filter membrane to prevent excessive mixing of the permeate and backflush liquid. However, if the conduits are arranged such that either or both of the inlet of the permeate conduit and outlet of the backflush conduit are too close to the downstream surface of the filter membrane the ability of the permeate conduit to receive liquid passing through the entire surface of the filter membrane and the ability of the backflush conduit to introduce backflush liquid to the entire surface of the filter membrane may be impeded. If either of these effects prevails, the efficiency of the filter membrane and, accordingly, the process will suffer because of a greater time required to produce an acceptable amount of permeate or composition of retentate, and increased requirements for backflush liquid.

With reference to FIGS. 2B and 2C and, in accordance with the present invention, preferably the permeate conduit is arranged such that the permeate inlet is located from about 10 to about 15 mm from the downstream surface of the filter membrane, more preferably from about 12 to about 14 mm from the downstream surface of the filter membrane. Preferably the backflush conduit is arranged such that the backflush outlet is located from about 10 to about 15 from the downstream surface of the filter membrane, more preferably from about 12 to about 14 from the downstream surface of the filter membrane.

In the embodiments of FIGS. 2B and 2C, the permeate inlet and backflush outlet are arranged at a sufficient distance downstream of the surface of the filter membrane such that they are also downstream of the conductivity electrodes.

With reference to FIGS. 3A and 3C and, in accordance with the present invention, preferably the permeate conduit is arranged such that the permeate inlet is located from about 1 to about 5 mm from the downstream surface of the filter membrane, more preferably from about 2 to about 4 mm from the downstream surface of the filter membrane. Preferably the backflush conduit is arranged such that the backflush outlet is located from about 1 to about 4 mm from the downstream surface of the filter membrane, more preferably from about 2 to about 3 mm from the downstream surface of the filter membrane.

In accordance with FIGS. 3A and 3C, the backflush outlet is preferably arranged at a distance closer to the downstream surface of the filter membrane than the permeate inlet.

In accordance with the present invention both the backflush and permeate conduits are located downstream of the filter membrane and, generally, the permeate and backflush conduits are arranged substantially normal to the filter membrane. In certain embodiments, either or both of the backflush and permeate conduits may be arranged such that an angle is formed between either or both conduits and a center line of the membrane normal thereto. The angle formed by the conduits may be from about 0 to about 90°. Typically, the angle formed by the conduits may be from about 15 to about 75°, more typically from about 30 to about 60° and, still more typically, from about 40 to about 50°.

Typically, one of the permeate and backflush conduits is concentrically disposed within the other and, preferably, the backflush conduit is disposed within the permeate conduit to form the annular space which defines the permeate passage, or, permeate reception zone. Generally, the cross-sectional area of the permeate conduit is from about 0.05 to about 500 mm² while the cross-sectional area of the backflush conduit is generally from about 0.05 to about 100 mm². When the backflush conduit is disposed within the permeate conduit, typically the ratio of the cross-sectional area of the permeate conduit to the cross-sectional area of the backflush conduit is at least about 2:1 and, more typically, is at least about 5:1. Preferably, the ratio of the cross-sectional area of the permeate conduit to the cross-sectional area of the backflush conduit is from about 10:1 to about 100:1. Reducing the cross-sectional area of the backflush conduit is an important feature of some embodiments of the present invention since it allows for a reduction in the overall size of the filtration head and/or an increase in the cross-sectional area of the permeate passage.

A variety of alternative schemes can be used for controlling the filtration cycle.

For example, in one embodiment, where the dispersion to be filtered is contained in a vessel, the vessel may be initially filled to a predetermined level and drawn down during each filtration phase to another predetermined level before the filter membrane is backflushed. After or during backflushing, washing liquid may optionally be added to bring the liquid level back to the initial predetermined value, or another predetermined value if desired.

In another embodiment, wash liquid may be added continuously during the filtration phase to maintain the liquid level at a substantially constant value, or intermittently to cycle the level within a predetermined range. In still another alternative, washing liquid may be added during backflushing.

In the backflushing phase, a fixed volume of backflush liquid may be passed through the membrane; or, alternatively, backflushing may be continued for a fixed period of time, or until the pressure drop across the membrane has dropped to a predetermined value at a fixed rate of backflush flow, or until the backflush flow rate has risen to a predetermined level at fixed pressure drop.

Those skilled in the art will recognize that the various alternatives for controlling the filtration phase may be combined with the alternatives for controlling the washing and backflushing phases, and that all compatible combinations are comprehended by the instant disclosure.

The frequency and volume of backflushing may be adjusted and controlled by an adaptive control system which measures productivity in terms of net permeate production in excess of backflush fluid over a filtration campaign comprising multiple cycles of filtration and backflushing. Conventional control software may be used to make systematic step increments in backflush volume and frequency, measure and integrate the permeate flow response over an appropriate number of cycles, and make further step changes in the direction of increasing net permeate flow until a maximum or defined optimum net permeate production is evolved.

A similar adaptive control scheme may be used to achieve a maximum rate of removal of soluble ionic species from the retentate, and/or optimal balance between productivity of permeate and removal of ionic species. In this instance, the software is implemented to make evolutionary adjustments to variables that may include the volume (absolute or proportional) of permeate removed per cycle, volume of washing liquid per cycle, backflush volume and/or backflush frequency.

As previously discussed, introduction of the backflush liquid to the filter membrane is directed to improving the filtration process by removing particulate material from the surface or vicinity of the upstream surface of the filter membrane. It has been discovered that either or both of the frequency of backflushing phases or volume of backflush liquid introduced to the filter membrane during a backflushing phase can be controlled to achieve a desired rate of production of permeate or to maintain a desired permeate flux. In accordance with the present invention either or both of the frequency of backflushing phases or volume of backflush liquid introduced to the filter membrane during a backflushing phase are controlled for optimum performance by being adjusted in response to the permeate flux or a function thereof. One method of monitoring flow through the filter membrane is observing the change in liquid level in the vessel.

In one embodiment of the present invention, the frequency of backflushing phases is adjusted to maintain a desired permeate flux. If the permeate flux as measured by the rate of change in liquid level in the vessel is lower than desired, the frequency of backflushing may be increased if it is believed the lower than desired permeate flux is due to the presence of particles on the upstream surface of the filter membrane. If it is believed the lower than desired permeate flux is due to insufficient net filtration time (i.e., the portion of a filtration and backflushing cycle directed to filtration is not sufficient) the frequency of backflushing may be decreased.

In another embodiment of the present invention, the volume of solvent introduced to the filter membrane during a backflushing phase is adjusted to maintain a desired permeate flux. Accordingly, if the permeate flux as measured by the change in liquid level in the vessel is lower than desired, the amount of liquid introduced to the filter membrane during a backflushing phase can be increased if it is believed that such an increase will result in increased permeate flux by reducing the amount of particles lodged in the pores, or present on or in the vicinity of the upstream surface of the filter membrane, and/or by providing a more dilute retentate. Alternatively, the amount of liquid introduced to the membrane during a backflushing phase may be decreased, thereby reducing the length of a backflushing phase, if the permeate flux is lower than desired and it is believed that this is due to insufficient filtration time between backflushing phases.

In accordance with the present invention the frequency of backflushing phases and volume of liquid introduced to the filter membrane during a backflushing phase may both be controlled to provide a desired rate of production of permeate. In one embodiment of the present invention, the frequency of backflushing phases and volume of liquid introduced to the filter membrane during a backflushing phase are controlled to provide a substantially maximum achievable rate of production of permeate and, in another embodiment, the actual rate of production of permeate is at least about 85% of the maximum achievable rate of production of permeate associated with an optimal combination of frequency of backflushing phases and volume of liquid introduced to the filter membrane during a backflushing phase.

The process of the present invention may include one or more cycles of alternating backflushing and filtration phases. The number of cycles can be chosen or determined based on numerous considerations, for example, the desired particulate concentration of retentate, the desired size distribution of particulate matter to be recovered in the retentate and the desired maximum particulate content of the permeate.

Alternating cycles of filtration and backflushing phases may be incorporated in a process further including continuous or intermittent addition of wash liquid to the retentate. In accordance with such a process, addition of wash liquid to the retentate can reduce the concentration of particulate material or soluble ionic materials within the retentate and, accordingly, the permeate, over a plurality of cycles.

In one embodiment of the present invention, the alternating cycles of backflushing and filtration phases may be continued until the conductivity of the retentate or permeate reaches a target value.

The present invention is further directed to various embodiments of a process for adjusting the composition of each of a plurality of dispersions each comprising particulate matter and a fluid medium. In certain embodiments, this process is carried out by concurrently exposing each of a plurality of filter membranes to a dispersion and concurrently causing fluid to flow through each of the filter membranes to form a permeate stream downstream of each filter membrane and a retentate upstream of each filter membrane. Each of the plurality of filter membranes is exposed to a separate dispersion and a plurality of separate permeates and retentates are formed. The process for adjusting the composition of a plurality of dispersions further includes introducing a wash liquid to each of the separate retentates. The flow through the filter membrane and addition of wash liquid to each of the separate retentates thus formed both proceed in accordance with the discussion set forth above. Each of the separate permeate streams flows into a separate permeate reception zone of a plurality of reception zones downstream of the filter membrane and each of the plurality permeate reception zone receives a single permeate stream.

In one embodiment of the process for adjusting the composition of a plurality of dispersions, the permeate reception zones comprise an array adapted for parallel delivery of each of the permeates to separate permeate reception zones.

The plurality of dispersions to be treated may be contained in a spatially discrete vessels, in each of which the plurality of filter membranes is exposed to a dispersion. In accordance with this embodiment, preferably the plurality of spatially discrete vessels are arrayed for a parallel operation in which a plurality of filter membranes are concurrently and severally exposed to a plurality of dispersions contained in the spatially discrete vessels such that fluid flows through each of the filter membranes concurrently. Also in accordance with this embodiment, the filter membranes and, accordingly, permeate reception zones, are oriented in an array corresponding to the array of the spatially discrete vessels.

During the process for adjusting the composition of a plurality of dispersions, fluid flows through each of the plurality of filter membranes during a filtration phase in a filtering direction. The process may further include a backflushing phase during which a liquid stream is introduced to each of the plurality of filter membranes in a backflushing direction directly opposite the filtering direction. The introduction of a backflush liquid to each of the plurality of filter membranes proceeds in accordance with the discussion set forth above.

In another embodiment of the process for adjusting the composition of a plurality of dispersions, each of the plurality of filter membranes is supported on a separate filtration head. In accordance with this embodiment, each of the filtration heads further comprises a permeate conduit comprising the permeate reception zone and a backflush conduit for introducing a backflush liquid to each of the filter membranes in a backflushing direction.

The present invention is further directed to a novel filtration apparatus for use in the process for adjusting the composition of a plurality of dispersions of particulate matter in fluid media. The apparatus comprises a plurality of filter membranes adapted such that fluid may flow through each of the filter membranes to form a plurality of permeate streams, a plurality of permeate conduits for receiving permeate, and a plurality of backflush conduits for directing a backflush liquid through the filter membranes. Generally, each of the plurality of permeate conduits is positioned to receive permeate from a membrane of the plurality of membranes that is separate from any of the plurality of membranes from which any other of the plurality of permeate conduits are positioned to receive permeate. In certain embodiments, each permeate conduit is preferably not in fluid flow communication with any other permeate conduit. Each of the plurality of backflush conduits is in fluid flow communication with a filter membrane and each backflush conduit is generally oriented for backflushing a membrane that is separate from any membrane which any of the other plurality of backflush conduits is oriented to backflush. In certain embodiments, each backflush conduit is preferably not in fluid flow communication with any other backflush conduit. The plurality of filter membranes are oriented in an array such that the plurality of dispersions can be introduced to the filter membranes contemporaneously with each of the plurality of filter membranes being exposed to a separate dispersion. Thus, the apparatus may be adapted for contemporaneous, parallel delivery of a dispersion to each of the plurality of filter membranes and, accordingly, contemporaneous, parallel passage of fluid through each of the plurality of filter membranes.

In accordance with the apparatus for use in the process for adjusting the composition of a plurality of dispersions, each of the plurality of permeate streams flows into one of a plurality of permeate reception zones comprising a spatially discrete permeate conduit downstream of each of the plurality of filter membranes. Each permeate conduit within a permeate reception zone is in fluid flow communication with a separate filter membrane and, in certain embodiments, each filter membrane is preferably in fluid communication with only a single permeate reception zone and, accordingly, a single permeate conduit.

Typically, the filtration apparatus for adjusting the composition of a plurality of dispersions comprises at least about 4 filter membranes. Preferably, at least about 6 filter membranes, and, more preferably, at least about 8 filter membranes. In some embodiments the apparatus will comprise arrays comprising 4n, 8n, 12n, 24n or 96n filter membranes, where n is in each case ranging from 1 to 5.

In one embodiment, the apparatus may be described as an assembly, preferably a structurally integrated assembly, comprising a plurality of filter membranes and permeate conduits. Typically, the apparatus will further comprise a plurality of backflush conduits in which each of the filter membranes is preferably in fluid flow communication with one of the plurality of the permeate conduits and one of the plurality of backflush conduits separate from the permeate conduit and backflush conduit with which any others of the filter membranes communicate. More particularly, the assembly comprises a plurality of spatially discrete filtering regions with each filtering region comprising a filter membrane, a permeate conduit and a backflush conduit and the assembly adapted such that a dispersion may be exposed to each of the plurality of filter membranes.

In one embodiment an assembly comprises a monolithic block comprising a plurality of filtering regions. In accordance with this embodiment each filtering region comprises a filter membrane, a corresponding permeate conduit and a corresponding backflush conduit. The backflush conduit and permeate conduit are both located downstream of the filter membrane and, generally, are arranged substantially normal to the filter membrane. In certain embodiments, either or both of the backflush and permeate conduits may be arranged parallel to or at a modest angle to the center line of the filter membrane substantially normal to the face thereof. Typically, one of the permeate and backflush conduits is concentrically disposed within the other within one or more of the filtering regions and, preferably, the backflush conduit is disposed within the permeate conduit to form an annular space between them for passage of the permeate stream. Generally, the cross-sectional area of the permeate conduit is from about 0.05 to about 500 mm² while the cross-sectional area of the backflush conduit is generally from about 0.05 to about 100 mm². Typically, the ratio of the cross-sectional area of the permeate conduit to the cross-sectional area of the backflush conduit is at least about 2:1. Preferably, the ratio of the cross-sectional area of the permeate conduit to the cross-sectional area of the backflush conduit is from least about 5:1 to about 100:1, more preferably from about 10:1 to about 50:1. In such an apparatus, either or both of the permeate conduit and backflush conduit can be formed by boring a portion of the monolithic block within the filtering region. If only the permeate conduit is formed by boring a portion of the monolithic block within the filtering region, the backflush conduit may be comprised of a conduit separate from the monolithic block and integrated into the apparatus. The apparatus also comprises means for introducing backflush liquid to each of the filter membranes and means for collecting the permeate streams which flow within each of the permeate conduits. The apparatus may comprise common means, e.g., a backflush manifold or header for introducing backflush liquid to each of the backflush conduits or separate means for introducing backflush liquid to each of the plurality of backflush conduits. The apparatus may also comprise common means (e.g., manifold or header) for collecting each of the permeate streams from the plurality of permeate conduits or may comprise separate means for collecting the permeate stream from each of the permeate conduits.

In another embodiment of the apparatus each of the plurality of filter membranes may be supported on a spatially discrete filtration head which is adapted for exposing the filter membrane to one of the plurality of dispersions. In addition to the filter membrane, each filtration head further comprises a permeate conduit and a backflush conduit. In accordance with this embodiment the apparatus may further comprise a plurality of spatially discrete vessels, each containing one of the plurality of dispersions, with each vessel adapted for exposure of only one of the plurality of filter membranes to the dispersion contained therein. Each filtration head is in accord with the description set forth above.

Thus, an assembly may also comprise a plurality of filtration heads, preferably a structurally integrated assembly, arrayed and adapted for concurrent filtration of a plurality of dispersions. The filtration heads may also, additionally or alternatively, be integrated from a process control perspective (i.e., in control communication with a common microprocessor). In such an embodiment, typically the apparatus comprises at least about 2 filtration heads, more typically at least about 4 filtration heads and, more typically, at least about 6 filtration heads. However, the number of specific filtration heads in an assembly described above varies widely depending on the particular application. When the assembly comprises a plurality of filtration heads, the apparatus also comprises means for introducing backflush liquid to each of the filter membranes and means for collecting the permeate streams which flow within each of the permeate conduits. The apparatus may comprise common means for introducing backflush liquid to each of the filter membranes and means for collecting each of the permeate streams or may comprise each type of means for each filter membrane. Each of the filtration heads incorporated in such an apparatus is in accordance with the description set forth above.

Whether the apparatus comprises an assembly comprising a plurality of filtering regions or a plurality of filtration heads the apparatus further comprises means for movement of the assembly in more than one direction in relation to the dispersion to be treated. Typically, the apparatus includes a robot arm in connection with the assembly and adapted for movement of the assembly and locating the filter membranes in a position in which they will be exposed to a dispersion.

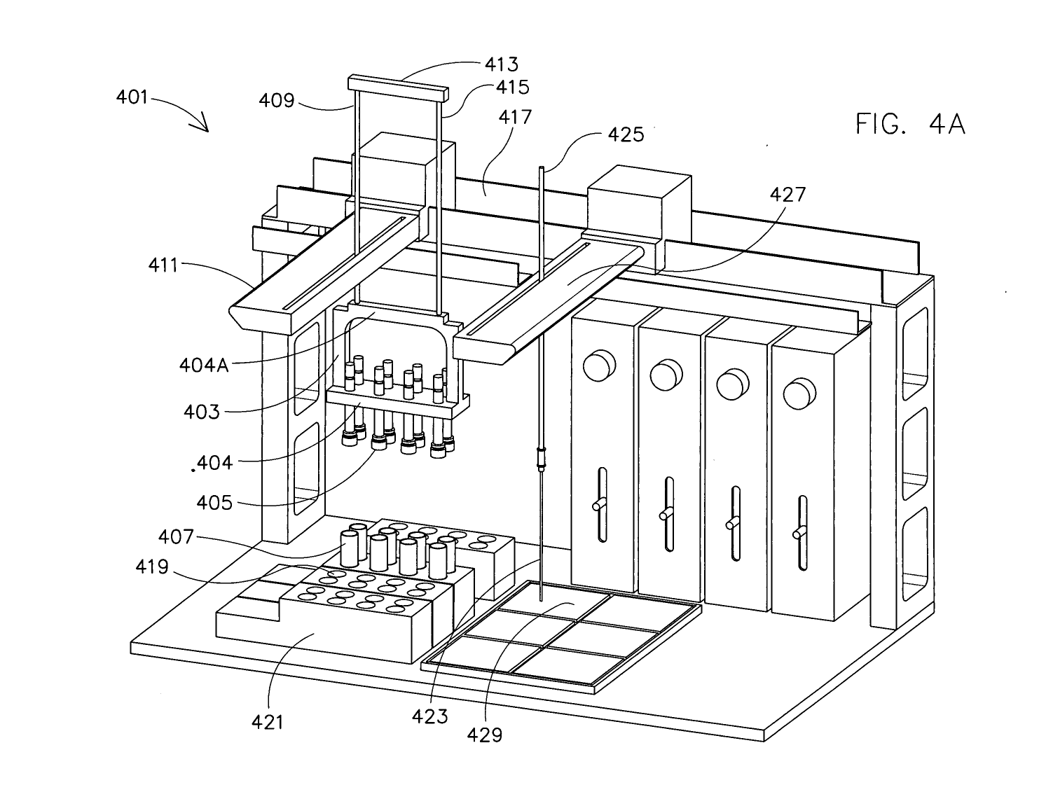

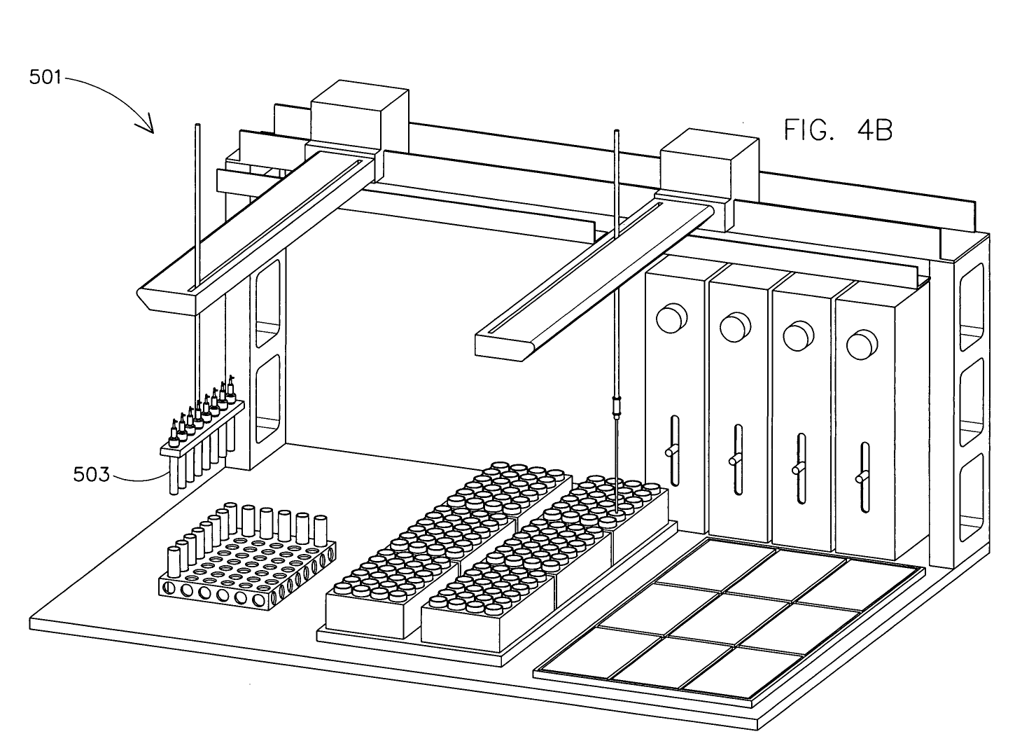

FIG. 4A depicts a parallel filtration module, generally designated 401, which includes an assembly 403 of eight filtration heads 405, each containing a filter membrane, and arrayed for filtration of each of a plurality of dispersions contained in each of the plurality of filtration vials 407.

Assembly 403 comprises a head holder 404 comprising a yoke 404A suspended at one end from a support rod 415 and at the other from the Z-axis rod 409 of an automatic robot arm 411 of an automatic robotic fluid delivery system, such as a liquid dispensing robot manufactured by Tecan Systems, Inc. under the trademark Cavro®, adapted for locating the assembly 403 containing the filtration heads in a filtering position by movement of the assembly 403 vertically with respect to the filtration vials 407. Rod 415 and Z-axis rod 409 are both connected at their upper ends to a stabilizer bar 413.

At a filtering position, each of the filtration heads 405 is placed such that a filter membrane is at least partially immersed in the dispersion present in a corresponding vial of the plurality of filtration vials 407. The automatic robot arm 411 is mounted on a track 417 adapted for movement of the automatic robot arm 411 and assembly 403 longitudinally along the track 417. The automatic robot arm is slotted and adapted for movement of the Z-axis rod longitudinally along the automatic robot arm 411. Thus, the location of the assembly and, accordingly, the filtration heads may be adjusted within the x-y-z coordinate system defined by the dimensions of the track 417, automatic robot arm 411, and Z-axis rod 409, respectively.

As shown in FIG. 4A, each of the filtration vials 407 is located over one of a plurality the magnetic stirring blocks 419 depicted in an array 421 corresponding to the array of the filtration heads 405. The adaptability of the assembly for movement within an x-y-z coordinate system as discussed above allows for filtration of dispersions contained within vials which are located on any of the magnetic stirring block arrays 421.

The parallel filtration module 401 also includes a slurry dispensing tip 423 connected to the Z-axis rod 425 of a second automatic robot arm 427 which moves the slurry dispensing tip between a lowered sampling position and a raised position. The slurry dispensing tip is adapted for depositing the sample removed from any of the filtration vials 407 onto a substrate 429 after which the sample may be dried and analyzed in accordance with one or more analytical methods (e.g., X-ray diffraction, Scanning Electron Microscopy).

The Z-axis rod 425 of the second automatic robot arm 427 in connection with the slurry dispensing tip 423 is configured in the manner of the automatic robot arm 411 discussed above such that the slurry dispensing tip 423 is adapted for movement within an x-y-z coordinate system defined by the dimensions of the track 417, second automatic robot arm 427, and Z-axis rod 425, respectively. Thus, the slurry dispensing tip 423 is adapted for movement such that it may be used for aspirating a sample from a filtration vial 407 situated on any of the magnetic stirring blocks 419 depicted in the multiple arrays 421 in FIG. 4A.

FIG. 4B represents a parallel filtration module, designated generally 501, in an alternative arrangement to that discussed above concerning FIG. 4A. The primary distinction between the parallel filtration module 501 of FIG. 4B and that of the parallel filtration module 401 of FIG. 4A is the orientation of the filtration heads 503. The details pertaining to the portions of the parallel filtration module 501 identical to those of parallel filtration module 401 will not be repeated.

In accordance with the present invention in which the composition of a single dispersion is adjusted or the composition of each of a plurality of dispersions is adjusted either serially or concurrently, a sample or samples of slurry comprising the retentate may be taken at one or more different points during the process. For example, samples may be taken after flow through the membrane or membranes has occurred for a certain period of time, after one or more dilution phases, after one or more backflushing phases, or upon completion of an entire filtration operation which may comprise one or more dilution or backflushing phases. The point at which the sample or samples are obtained generally depends on the desired concentration of sample or samples, and the extent which it is elected to process the retentate for removal of soluble contaminants. One feature of the parallel filtration modules 401 and 501 depicted in FIG. 4A and FIG. 4B, respectively, is the adaptability of the slurry dispensing tip 423 for removing samples from a filtration vial.

The recovered sample or samples may then be deposited on a substrate, dried, and subjected to one or methods of analysis. The recovered solids may be recovered and analyzed to test for various properties including, for example, catalytic activity, molecular weight, and impurity content. In certain embodiments, samples may be analyzed to determine whether the sample satisfies a desired minimum impurity content, maximum impurity content, or an optimum impurity content; “impurity” in this sense including any soluble component, desirable, undesirable or inert, which can be removed by washing (i.e., dilution and further filtration) of the retentate. In the case of microporous or mesoporous materials such as zeolites, the dried solids obtained may be subjected to X-ray diffraction (XRD) analysis, analyzed with a scanning electron microscope (SEM) or electron diffraction spectroscopy (EDS). Methods for scanning XRD are known in the art and include, for example, those described in U.S. Pat. No. 6,371,640, the disclosure of which is hereby incorporated by reference. Methods for scanning SEM and EDS are also known in the art and include, for example, those described in U.S. Pat. No. 5,985,356, the disclosure of which is hereby incorporated by reference.

The dried particles recovered from the slurries may be subjected to various mechanical treatments known in the art including, for example, grinding, pressing, crushing, sieving, preferably in parallel, to prepare the materials for certain uses including, for example, incorporation into catalyst material. One suitable pressing method includes cold isostatic pressing. Methods for parallel grinding, pressing, crushing, and sieving operations are generally known in the art and include, for example, those disclosed in International Publication No. WO 02/04121 and U.S. 2002-0014546 published Feb. 7, 2002, the entire disclosures of which are hereby incorporated by reference.

A filtration process carried out in accordance with the present invention in which a single dispersion comprising particulate matter and a fluid medium is treated or such a process in which a plurality of such dispersions are treated serially or concurrently may be incorporated into overall process workflows or combinatorial protocols in which a filtration step is necessary or desirable. Various of such combinatorial workflows may include, among other steps, synthesis of catalyst materials and screening for one or more properties. In these types of applications, a combinatorial workflow may generally comprise one or more of the following steps: experimental planning/catalyst library design; synthesis of catalyst or catalyst precursor library; optional pretreatment of the catalyst or catalyst precursor library (e.g., chemical treatment such as precursor decomposition, physical treatment such as calcining or washing, or a mechanical treatment such as grinding or pressing); optional characterization of the catalyst or catalyst precursor library (e.g., using x-ray diffraction (XRD) to determine one or more characteristics of the catalyst or catalyst precursor library); screening of the catalyst candidates based on performance in liquid or gas phase reactions carried out in different manners (e.g., flow, semi-continuous, batch); optional characterization of the screened catalyst candidates; optional catalyst regeneration; optional screening of regenerated catalyst in reactions carried out as described above; optional data processing; data analysis; optional repetition of one or more of the previous steps, possibly including automated resynthesis. The filtration process of the present invention may be incorporated into such a combinatorial protocol between material synthesis and the optional pretreatment and characterization steps described above.

It will be understood that the workflow processes in which the liquid/solid separation step is conducted are not limited to the combinatorial preparation of active catalysts. For example, where the dispersion subjected to filtration comprises a mesoporous or microporous material such as a zeolite, the recovered solids may optionally be performance tested in a variety of applications, including function as a support for another catalyst active phase, e.g., a noble metal, or as a molecular sieve or adsorbent for use in separations. Analytical tests such as XRD or SEM may also be oriented toward evaluation of structure as related to such other performance requirements.

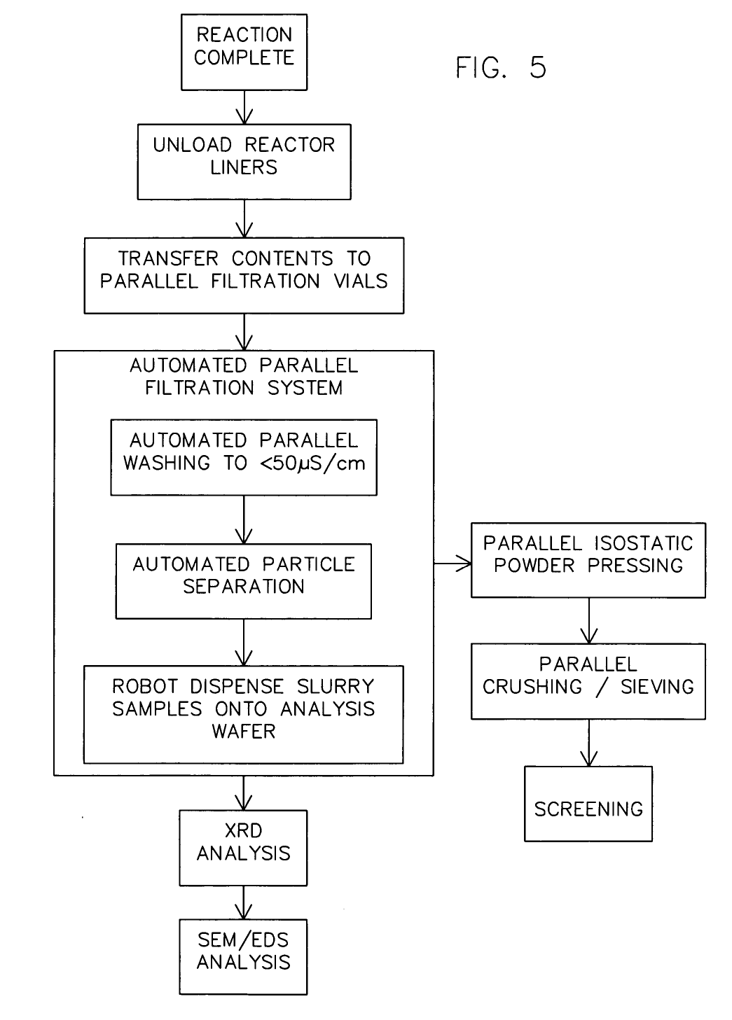

FIG. 5 generally depicts a process in which the parallel filtration method of the present invention is incorporated into an overall workflow including a reaction step and analysis of the filtered materials (e.g., by XRD analysis or SEM/EDS analysis) and/or recovery and further treatment of the filtered materials (e.g., parallel isostatic powder pressing or parallel crushing and sieving of the recovered materials). The workflow depicted in FIG. 5 includes a synthesis reaction conducted in a vessel or vessels to produce a dispersion or dispersions comprising particulate matter in a liquid medium (i.e., slurry) to be treated by the present process. Typically the filtration process of the present invention may be carried out in the same vessels as the synthesis reaction. Thus, in the context of an overall workflow incorporating the filtration process of the present invention, an optional benefit is elimination of the need to transfer the slurry to a different vessel before proceeding with the process of the present invention. Elimination of this step can increase the efficiency of an overall workflow and reduce the amount of solids lost when transferring material between vessels. Such workflows incorporating the present process for adjusting the composition of a plurality of dispersions may be carried out utilizing either of the parallel filtration modules 401 and 501 depicted in FIGS. 4A and 4B, respectively, and discussed above.

The following example is simply intended to further illustrate and explain the present invention. This invention, therefore, should not be limited to any of the details in this example.

### EXAMPLE 1

In the present example, the compositions of eight samples containing microporous crystalline particles were adjusted using a parallel microfiltration device.

The eight samples contained microporous crystalline particles obtained in a parallel synthesis reaction which were loaded into the filtration device upon completion of the reaction.

The eight samples consisted of mixtures containing from about 250 to about 1000 mg of solid particles dispersed in approximately 10 ml of water. Each filtration head of the parallel microfiltration device contained hydrophilic, polyvinylidene fluoride (PVDF) Durapore® membranes manufactured by Millipore (Billerica, Mass.) having a diameter of 13 mm, an average pore size of 0.45 μm, and a porosity of 70%. The initial ionic strength of the samples ranged from about 5.75 to about 113,000 μSiemens/cm.

Filtration was performed automatically and sequentially. The samples were washed first to remove undesired ions, soluble material, and fine particles of amorphous material. Automated filtration was performed in 6 (six) filtration cycles as determined by the conductivity measurements and the pre-programmed conductivity target. Each filtration cycle consisted of the following series of steps:

1. All samples were diluted by the addition of clean solvent up to a pre-programmed liquid level. A liquid handling robot using capacitive liquid level detection carried out the dilution in all cases.

2. Sample conductivities were measured using the same liquid handling robot to determine if washing was completed.

3. All filter heads were immersed and the following series of sub-steps was executed repeatedly until half of the liquid volume in each vessel had been removed as determined by the liquid level in each vial:

a. Vacuum was applied to cause flow out of the sample vials through the filter membranes of each filter head and out through the permeate channels of the filtration heads to a common collection reservoir.

b. After a nominal 4 second delay the vacuum was turned off and pressure applied to cause check valves near the permeate outlet of each head to close preventing flow from the filter heads through the permeate channels.

c. Immediately after sealing the permeate channels a parallel syringe pump injected a nominal volume of 275 μliters through each backflush channel of the filtration heads. This caused a momentary flow reversal across all membranes.

d. Immersion depth of the filtration heads was adjusted to maintain a nominal pre-programmed immersion depth of the heads in their sample vessels.

e. The 4 second delay time was automatically adjusted up or down depending upon the rate of liquid removal.

f. Steps a through e were repeated until half of the liquid volume in each vessel had been removed.

4. After half of the liquid volume in each vessel had been removed the filtration cycle was begun again at step 1. above.

After all samples were measured to have conductivities equal to or less than the pre-programmed conductivity target the concentration was complete. At this point automated filtration was performed. The automated filtration process consisted of sub-steps (a.) through (d.) of step 3 above. These were repeated until all vessels had no more than 1 mL of sample volume remaining in each vessel. The filter heads were then moved by the liquid handling robot so that none of the heads were submerged in any sample. 500 μliters of clean solvent was backflushed through each of the filter membranes to remove any residual solids.

The sample vials were then removed from the apparatus and deposited in an oven for drying.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1-99. (canceled)

100: A process for adjusting the composition of each of a plurality of dispersions comprising particulate matter and a fluid medium, the process comprising:
concurrently exposing each of a plurality of filter membranes to a dispersion of said plurality of dispersions, the dispersion to which each of said plurality of membranes is exposed being separate from any dispersion to which any other of said plurality of membranes is exposed;
concurrently causing fluid to flow through each of said membranes to form a permeate downstream of each membrane and a retentate upstream thereof, thereby forming a plurality of separate permeates and a plurality of separate retentates; and
introducing a wash liquid into each of said separate retentates.

101: A process as set forth in claim 100 further comprising flow of the plurality of permeates into a plurality of permeate reception zones, each of said plurality of permeates flowing into a reception zone that is separate from any reception zone into which any other of said plurality of permeates flows.

102: A process as set forth in claim 101 wherein said plurality of permeate reception zones comprises an array of permeate reception zones oriented for parallel delivery of said plurality of permeates to said plurality of reception zones.

103: A process as set forth in claim 100 wherein each of said plurality of dispersions is separately exposed to a filtration membrane in one of a plurality of spatially discrete vessels.

104: A process as set forth in claim 103 wherein said plurality of vessels comprises an array of vessels oriented for parallel filtration operations.

105: A process as set forth in claim 100 wherein each of said plurality of filter membranes is supported on one of a plurality of filtration heads.

106: A process as set forth in claim 105 wherein each of said filtration heads comprises a permeate conduit for flow of permeate in a filtering direction and a backflush conduit for introducing a backflush liquid to each of said plurality of filter membranes in a backflushing direction.

107: A process as set forth in claim 100 wherein fluid flows through said filter membranes in a filtering direction during a filtration phase and further comprising a backflushing phase wherein a liquid stream is introduced to said plurality of filter membranes in a backflushing direction.

108: A process as set forth in 100 wherein said plurality of filter membranes comprises an array of filter membranes oriented for parallel delivery of said plurality of dispersions to said plurality of membranes.

109-160. (canceled)

161: An apparatus for filtration of each of a plurality of dispersions of particulate solids in fluid media, the apparatus comprising:
a plurality of filter membranes, each adapted for flow of fluid therethrough in a filtering direction to form a plurality of separate permeate streams;
a plurality of permeate conduits, each of said permeate conduits being positioned to receive permeate from a membrane of said plurality of membranes that is separate from any of said plurality of membranes from which any other of said plurality of permeate conduits is positioned to receive permeate; and
a plurality of backflush conduits for directing a backflushing liquid through said filter membranes, each of said backflush conduits being oriented for backflushing a membrane that is separate from any membrane which any other of said plurality of backflush conduits is oriented to backflush.

162: The apparatus as set forth in claim 161 wherein said plurality of filter membranes comprises an array of filter membranes oriented for contemporaneous parallel delivery of said plurality of dispersions to said plurality of membranes.

163: The apparatus as set forth in claim 162 further comprising a plurality of permeate reception zones, each of said permeate reception zones being in fluid flow communication with a membrane of said plurality, each of said plurality of reception zones being positioned to receive permeate from a membrane different from the membrane from which any other of said plurality of reception zones is positioned to receive permeate.

164: The apparatus as set forth in claim 163 wherein said plurality of permeate reception zones comprises an array of permeate reception zones oriented for contemporaneous parallel delivery of said plurality of permeates to said plurality of reception zones.

165: The apparatus as set forth in claim 161 further comprising a plurality of spatially discrete vessels, each of said vessels being operatively associated with a membrane of said plurality of membranes for exposure of the membrane to a dispersion contained in the vessel, the membrane with which each of said plurality of vessels is associated being separate from any membrane with which any other of said plurality of vessels is associated.

166: The apparatus as set forth in claim 165 wherein said plurality of vessels comprises an array of vessels oriented for contemporaneous parallel filtration operations.

167: The apparatus as set forth in claim 161 wherein said filter membranes, permeate conduits and backflush conduits comprise an assembly.

168: The apparatus as set forth in claim 167 further comprising a robot arm connected to said assembly.

169: The apparatus as set forth in claim 168 wherein said robot arm can be adapted for locating said assembly such that said filter membranes are in a filtering position.

170: The apparatus as set forth in claim 169 wherein said robot arm can be adapted for movement of said assembly in the vertical direction.

171: The apparatus as set forth in claim 170 wherein said assembly is adapted for placement in a filtering position such that each of said filter membranes is positioned to receive a dispersion separate any of the other dispersions of said plurality of dispersions.

172: The apparatus as set forth in claim 171 wherein said assembly is adapted for placement in a filtering position by lowering said assembly.

173: The apparatus as set forth in claim 172 wherein said assembly is adapted for placement in a filtering position by securing said assembly in a fixed position.

174: The apparatus as set forth in claim 173 wherein said assembly comprises a monolithic support comprising a plurality of spatially discrete filtering regions, each of said plurality of filtering regions comprising a filter membrane, a spatially discrete backflush conduit and a spatially discrete permeate conduit.

175: The apparatus as set forth in claim 173 wherein said assembly comprises a plurality of spatially discrete filtration heads, each of said plurality of filtration heads comprising a filter membrane, a permeate conduit and a backflush conduit.

176: The apparatus as set forth in claim 175 wherein said assembly comprises means for securing said filtration heads in an array.

177: The apparatus as set forth in claim 175 further comprising a plurality of vessels containing dispersion specimens and being arranged in an array corresponding to the array of said filtration heads, said assembly adapted for placement in a position whereby each of said plurality of filter membranes is immersed in the dispersion present in one of said vessels separate from any vessel in which any other of said filter membranes is positioned.

178: A process for adjusting the composition of a dispersion comprising particulate matter and a fluid medium, the process comprising:
exposing a surface of a filter membrane to a dispersion comprising particulate matter and a fluid medium, the dispersion having a first concentration of the particulate matter in the fluid medium,
removing some of the fluid medium from the dispersion by causing fluid to flow through the membrane to form a permeate downstream of the membrane and a retentate upstream thereof, whereby the concentration of the particulate matter in the fluid medium of the retentate increases over time relative to the first concentration of the dispersion, and
sampling the retentate intermittently over time to form at least two retentate samples, the at least two retentate samples having different concentrations of particulate matter in the fluid medium.

179: The process of claim 178 wherein the filter membrane is supported on a filtration head.

180: The process of claim 178 further comprising introducing a wash liquid into the retentate.

181: The process of claim 178 wherein the retentate is sampled using a automated sampling robot.

182: The process of claim 178 wherein the retentate samples are deposited on a common substrate.

183: The process of claim 182 further comprising analyzing the retentate samples for a property of interest.

184: A process for adjusting the composition of each of a plurality of dispersions comprising particulate matter and a fluid medium, the process comprising:
concurrently exposing each of a plurality of filter membranes to a dispersion of said plurality of dispersions, the dispersion to which each of said plurality of membranes is exposed being separate from any dispersion to which any other of said plurality of membranes is exposed;
removing some of the fluid medium from each of the plurality of dispersions by concurrently causing fluid to flow through each of said membranes to form a permeate downstream of each membrane and a retentate upstream thereof, thereby forming a plurality of separate permeates and a plurality of separate retentates; and
sampling each of the plurality of retentates to form at least two separate retentate samples.

185: The process of claim 184 wherein each of the filter membranes are supported on discrete filtration heads.

186: The process of claim 184 further comprising introducing a wash liquid into each of the plurality of retentates.

187: The process of claim 184 wherein the plurality of retentates are sampled using one or more automated sampling robots.

188: The process of claim 184 wherein the retentate samples are deposited on a common substrate.

189: The process of claim 188 further comprising analyzing each of the plurality of retentate samples for a property of interest.

190: The process of claim 178 further comprising analyzing the retentate samples for a property of interest.

191: The process of claim 184 further comprising analyzing each of the plurality of retentate samples for a property of interest.
